(19) United States
(12) Patent Application Publication
(10) Pub. No.: US 2015/0093245 A1
(43) Pub. Date: Apr. 2, 2015

(54) MOTION CONTROLLED HELICOPTER AND ROTATION RATE SWITCHED FLUID LEAD LAG DAMPER

(71) Applicant: LORD Corporation, Cary, NC (US)

(72) Inventors: Zachary Fuhrer, Erie, PA (US); Mark Jolly, Raleigh, NC (US); Conor M. Marr, State College, PA (US)

(21) Appl. No.: 14/389,847

(22) PCT Filed: Apr. 5, 2013
(86) PCT No.: PCT/US2013/035468

§ 371 Date: Oct. 1, 2014

Related U.S. Application Data
(60) Provisional application No. 61/620,597, filed on Apr. 5, 2012.

(51) Int. Cl. B64C 27/51; F16F 9/504

(52) U.S. Cl. CPC B64C 27/51; F16F 9/504
USPC 416/106; 416/145

(57) ABSTRACT

A method for controlling helicopter ground resonance and air resonance motions as well as centrifugal force switching dampers are disclosed. A helicopter lead-lag damper (30) has a first ground resonance motion damping rate stage (FDR) and a second air resonance motion damping rate stage (SDR). The damper (30) includes a centrifugal force switch (52). The damper (30) is oriented relative to the rotary wing rotation axis (26) and helicopter blade (24). An in-flight rotation rate of the centrifugal force switching damper (30) actuates the centrifugal force switch (52) with the damper switching from the first ground resonance motion damping rate stage (FDR) to the second air resonance motion damping rate stage (SDR).

### FIELD OF THE INVENTION

The invention relates to the field of helicopters machines and the control of troublesome motions in helicopters. The invention relates to the field of dampers for controlling motions in rotary systems. More particularly the invention relates to the field of lead lag dampers for controlling troublesome helicopter motions related to the rotation of helicopter blades.

### BACKGROUND OF THE INVENTION

There is a need for helicopter lead lag dampers for controlling troublesome motions in helicopters. There is a need for helicopter lead lag dampers for efficiently and accurately controlling helicopter motions while the helicopter is both out of flight and in-flight. There is a need for dampers which accurately and economically control motion and minimize vibrations. There is a need for an economically feasible method of controlling helicopter motions and method of making functional helicopter dampers. There is a need for an economic rotary system with dampers for providing beneficial controlled motions of helicopters and helicopter rotating blades.

### SUMMARY OF THE INVENTION

In an embodiment, the invention includes a method of controlling troublesome helicopter motions. The method includes providing a helicopter with a rotary wing system with at least a first rotating blade rotating about a rotary wing rotation axis, the helicopter having a first troublesome ground resonance motion and a second troublesome air resonance motion during helicopter flight with an in-flight rotary wing system rotation rate about the rotary wing rotation axis. The method includes providing at least a first centrifugal force switching damper, the first centrifugal force switching damper having at least a first ground resonance motion damping rate stage and at least a second air resonance motion damping rate stage. The method includes orienting the first centrifugal force switching damper in relationship to the rotary wing rotation axis and the first rotating blade, wherein an in-flight rotation of the first centrifugal force switching damper about the rotary wing rotation axis centrifugally switches the first centrifugal force switching damper from the first ground resonance motion damping rate to the second air resonance motion damping rate.

In an embodiment the invention includes a helicopter damper for controlling a first troublesome ground resonance motion during ground engagement and a second troublesome air resonance motion during helicopter flight. The helicopter damper has a first high damping rate (FDR) for controlling the first troublesome ground resonance motion and a second low damping rate (SDR) for controlling the second troublesome air resonance motion. The helicopter damper includes a centrifugal force switch, wherein an in-flight rotation of the helicopter damper centrifugal force switch reduces the first high damping rate (FDR) down to the second low damping rate (SDR).

In an embodiment, the invention includes a damper. The damper includes a first variable volume fluid working chamber and a second variable volume fluid working chamber with a first damping fluid flow conduit providing a first damping fluid flow between the first variable volume fluid working chamber and the second variable volume fluid working chamber. The damper includes a second damping fluid flow conduit between the first variable volume fluid working chamber and the second variable volume fluid working chamber. The damper includes a biased mass, wherein the biased mass is biased to obstruct a second damping fluid flow through the second damping fluid flow conduit at a first low speed rotation about an axis, and a second high speed rotation about the axis moves the biased mass to unobstruct the second damping fluid flow through the second damping fluid flow conduit.

In an embodiment, the invention includes a method of making a damper having an inboard end and an outboard end. The method includes providing a first variable volume fluid working chamber and a second variable volume fluid working chamber with a first damping fluid flow conduit between the first variable volume fluid working chamber and the second variable volume fluid working chamber, and a second damping fluid flow conduit between the first variable volume fluid working chamber and the second variable volume fluid working chamber. The method includes providing a mass. The method includes providing a spring. The method includes orienting the mass and the spring between the inboard end and the outboard end proximate the second damping fluid flow conduit wherein the second damping fluid flow conduit is obstructed with the spring biasing the mass towards the inboard end, and a rotation of the damper about an axis proximate the inboard end unobstructs the second damping fluid flow conduit.

In an embodiment, the invention includes a machine. The machine includes a rotary system rotating about a rotation axis. The machine has a first motion during rotation about the rotation axis at a first low rotation rate and a second motion during rotation about the rotation axis at a second high rotation rate. The machine includes a centrifugal force switching fluid damper, the centrifugal force switching fluid damper having a first motion damping rate stage and a second motion centrifugally switched damping rate stage switched with a centrifugal force inertia switch, the centrifugal force switching fluid damper oriented relative to the rotation axis wherein the second high rotation rate centrifugally switches the centrifugal force switching fluid damper from the first motion damping rate stage to the second motion centrifugally switched damping rate stage with the second motion centrifugally switched damping rate stage damping the second motion.

In an embodiment, the invention includes a process. The process includes providing a helicopter rotor which rotates about a helicopter axis of rotation. The process includes providing a rotation rate switched fluid damper containing a damper fluid in a fluid damper housing, the rotation rate switched damper housing having an inboard end and an outboard end. The process includes orienting the rotation rate switched fluid damper with the inboard end proximate the helicopter axis of rotation and the outboard end distal from the helicopter axis of rotation wherein a helicopter out of flight rotation of the helicopter rotor and the oriented rotation rate switched fluid damper, provides a first damping rate (FDR). A helicopter in-flight rotation of the helicopter rotor and the oriented rotation rate switched fluid damper provides a second damping rate (SDR) with FDR>SDR.

### BRIEF DESCRIPTION OF THE DRAWINGS

FIGS. 1A-B illustrate an out of flight helicopter with dampers for controlling troublesome ground resonance motions.

FIGS. 2A-B illustrate an in-flight helicopter with dampers for controlling troublesome air resonance motions.

FIG. 3 illustrates an in-flight helicopter with an oriented damper shown in a blown-up cross section with the inertia moving mass centrifugal force switch providing the lowered second damping rate.

FIG. 4A illustrates a cross section of a damper with a centrifugal force switch inertia moving mass obstructing the secondary damper orifice and the flow of damper fluid through the secondary conduit to provide the higher primary damping rate.

FIG. 4B illustrates the cross section of the damper under the centrifugal loading with the centrifugal force switch inertia moving mass opening the secondary damper orifice and the flow of damper fluid through the secondary conduit to provide the lower second damping rate.

FIG. 4C further illustrates the damper cross section in FIG. 4A.

FIG. 4D further illustrates the damper cross section in FIG. 4B with the secondary fluid flow path through the opened conduit illustrated by arrows and connected dots and with arrows illustrating the damper piston motion relative to the damper housing.

FIG. 5A illustrates a cross section of a damper piston with a centrifugal force switch inertia moving mass obstructing the secondary damper orifice and the flow of damper fluid through the secondary conduit to provide the higher primary damping rate.

FIG. 5B illustrates the cross section of the damper piston under the centrifugal loading with the centrifugal force switch inertia moving mass opening the secondary damper orifice and the flow of damper fluid through the secondary conduit to provide the lower secondary damping rate.

FIG. 6 illustrates a helicopter machine rotary system with an oriented damper shown in a blown-up cross section with the inertia moving mass centrifugal force switch obstructing the secondary conduit to provide the higher first damping rate.

FIG. 7A illustrate a cross section of a damper with a centrifugal force switch sliding ring inertia moving mass obstructing the flow of damper fluid through the secondary conduit to provide the higher primary damping rate.

FIG. 7B illustrates the damper with the centrifugal force switch sliding ring inertia moving mass unobstructing the flow of damper fluid through the secondary conduit under the centrifugal loading to provide the second damping rate.

FIG. 7C further illustrates the damper of FIG. 7A with damper inboard and outboard ends for connections with the helicopter rotary wing system.

FIG. 8 illustrates a cross section of an inner damper assembly for a damper with inner variable volume working chambers separated by a damper piston with a sliding moving mass opening the embedded secondary bypass channel fluid flow conduit through the damper piston to provide the second damping rate.

FIG. 9A illustrates a cross section of an alternate embodiment of a lead-lag damper assembly.

FIG. 9B illustrates positioning of the alternate embodiment lead-lag damper assembly on a rotary hub.

FIG. 10A illustrates a ground resonance condition first damping rate (FDR) with the orifices of the alternate embodiment lead-lag damper blocked, creating a high damping condition.

FIG. 10B illustrates an air resonance condition second damping rate (SDR) with the orifices of the alternate embodiment lead-lag damper open, creating a reduced damping condition.

FIG. 11 illustrates a cross section of a model of the alternate embodiment lead-lag damper used for computational fluid dynamic (CFD) modeling.

FIG. 12 illustrates a CFD model of the alternate embodiment lead-lag damper cross section depicting flow through a single orifice at a given time step in the damper oscillatory motion.

FIG. 13 illustrates a detail view from FIG. 12 depicting the orifice exit with high-speed flow and recirculation.

FIG. 14 illustrates a CFD model of the alternate embodiment lead-lag damper having a bypass channel and creating a pressure differential, thereby depicting that damping is reduced by opening a bypass channel, while improving internal flow patterns and generating less recirculation.

FIG. 15 illustrates a CFD model of the alternate embodiment lead-lag damper having a secondary orifice and creating a pressure differential, thereby depicting that damping is reduced by opening a secondary orifice, while improving internal flow patterns and generating less recirculation.

FIG. 16 illustrates a detail view from FIG. 15, further depicting the flow split between the secondary orifice and the main orifice, resulting in lower flow speeds and lower pressure differentials, and thus lower damping.

FIGS. 17A and 17B illustrate the CFD prediction of damper force and damping.

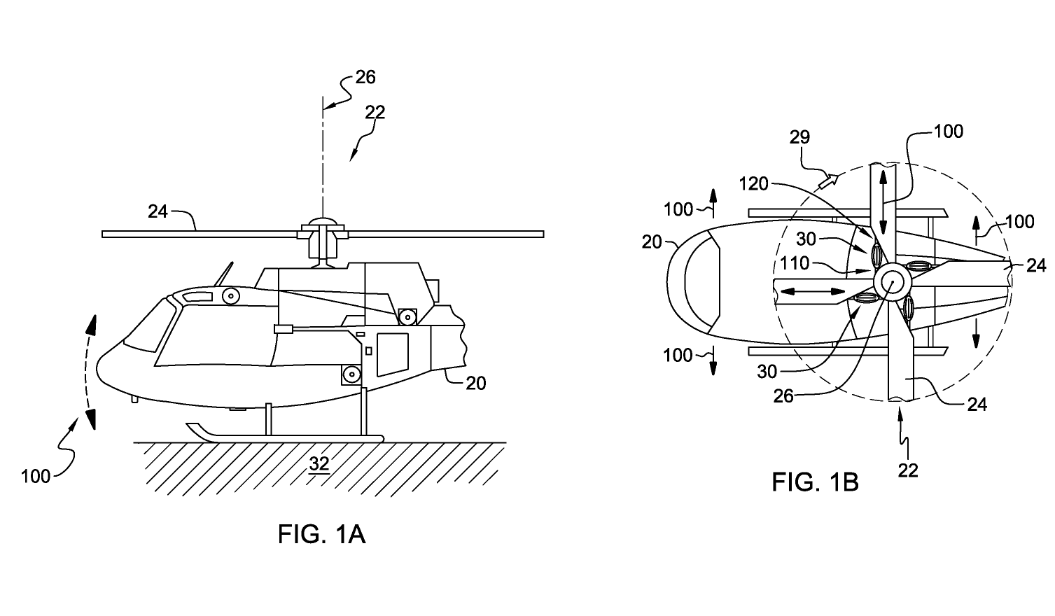

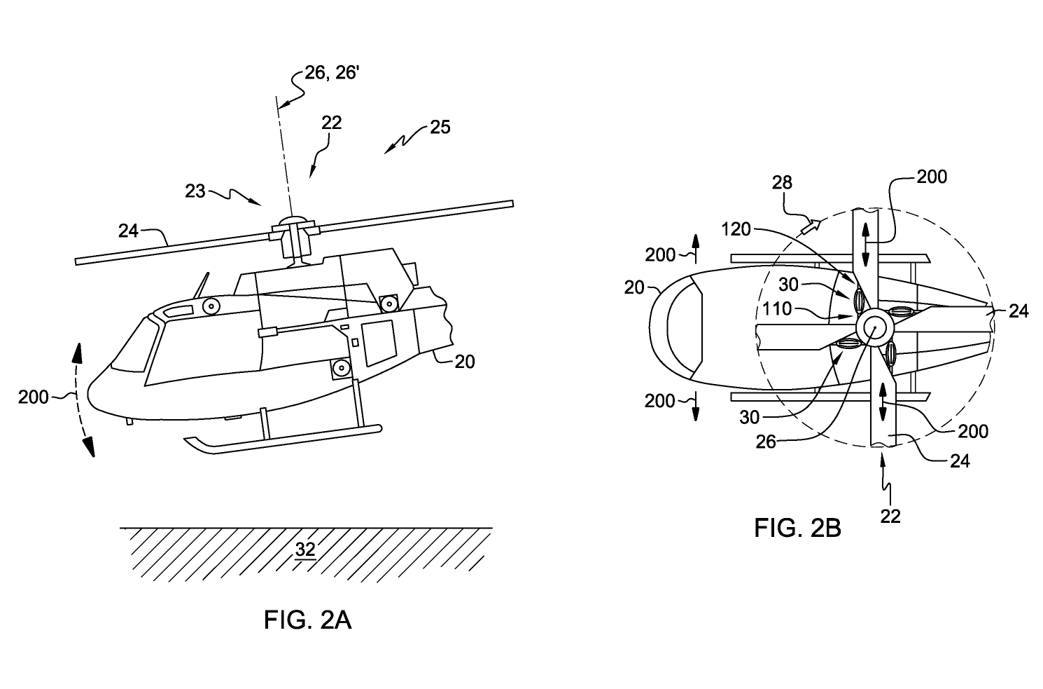

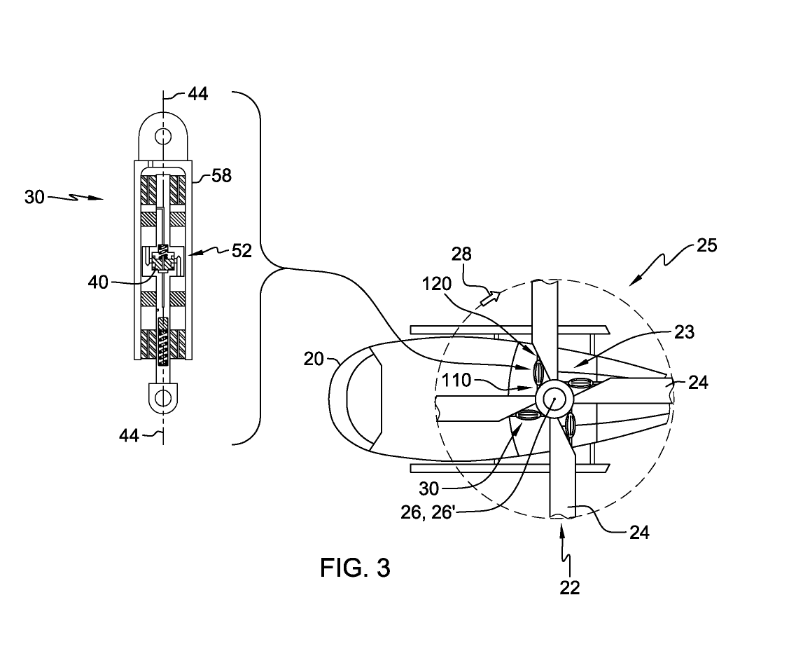

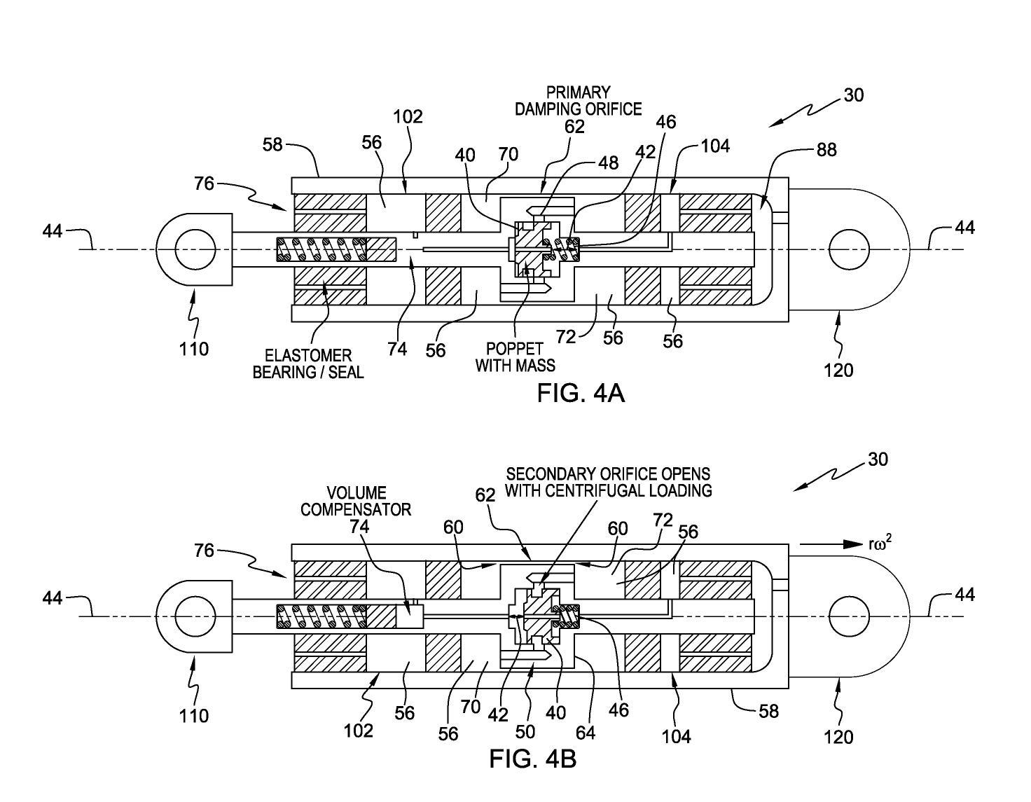

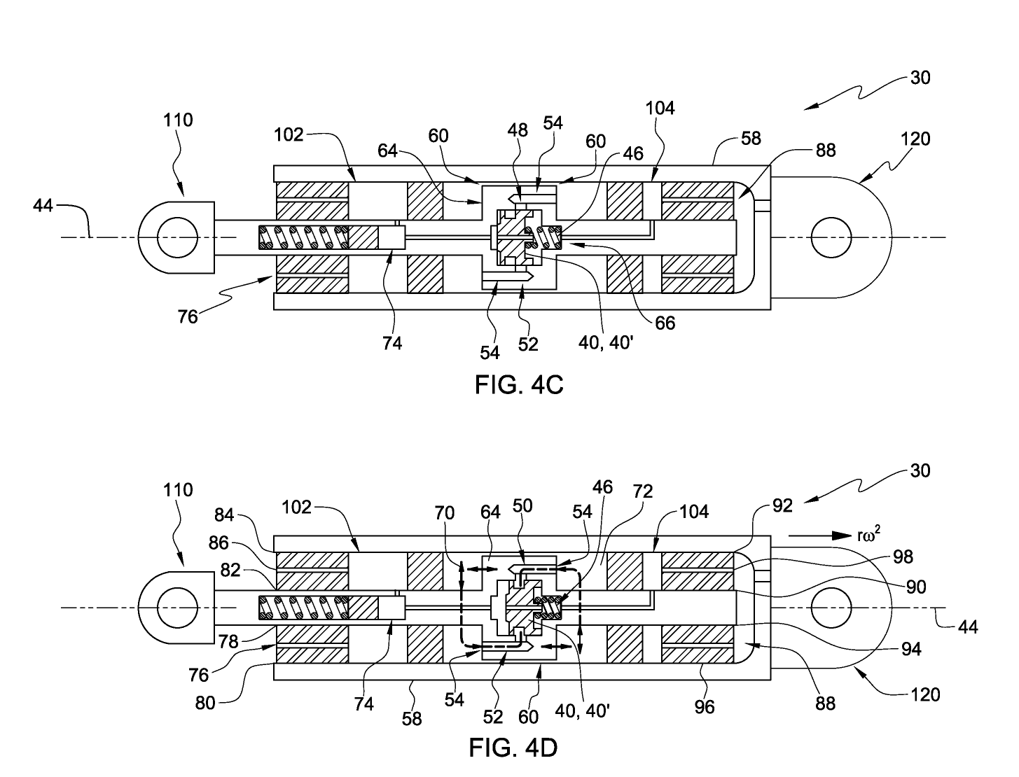

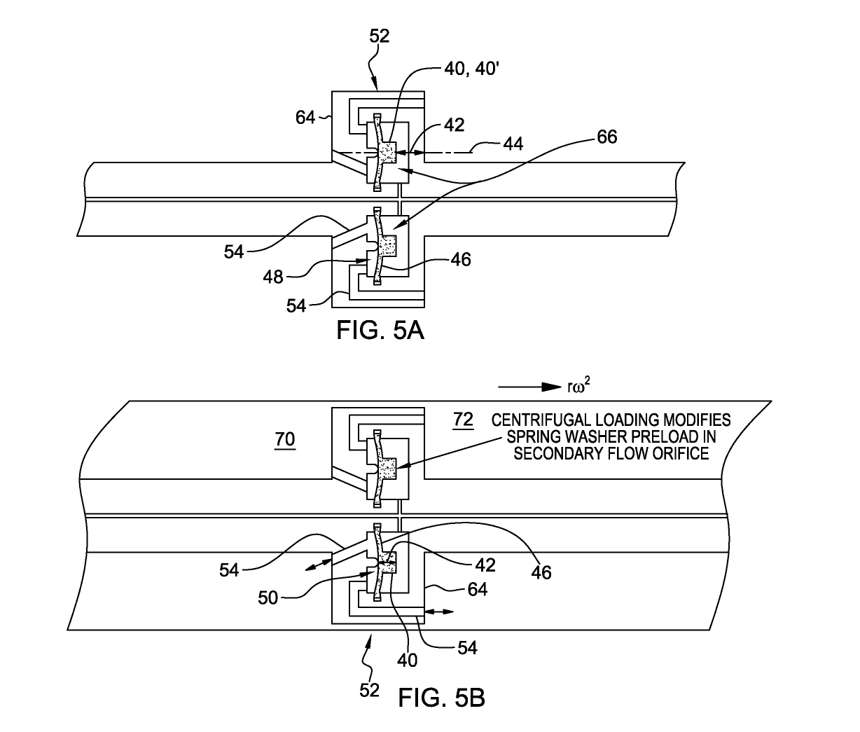

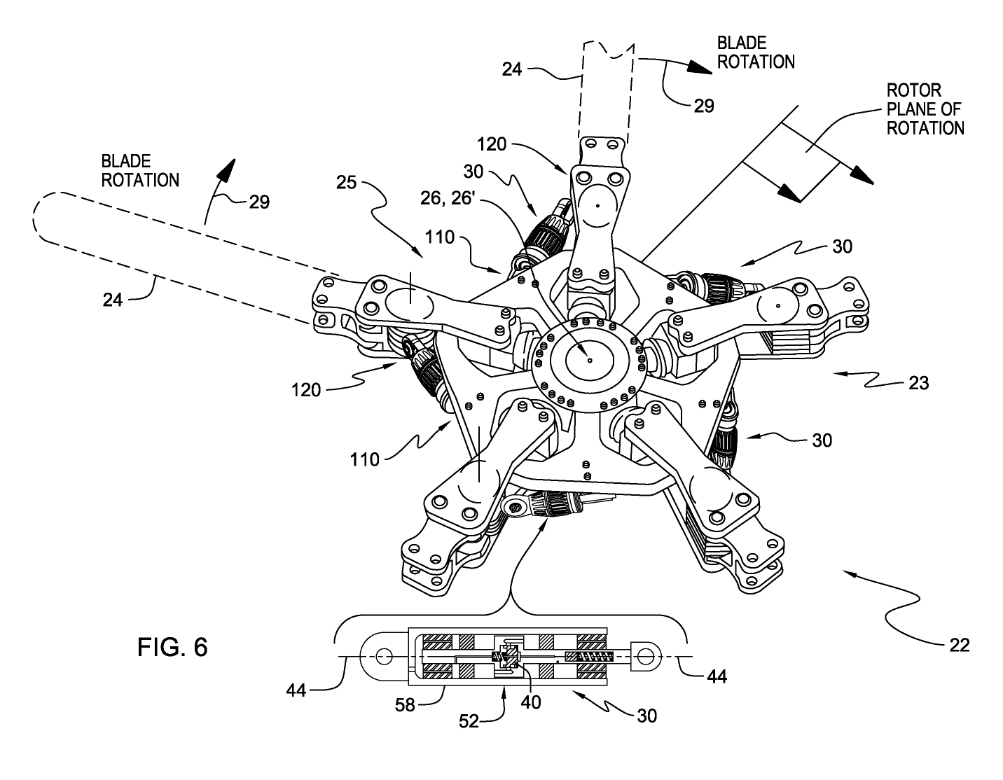

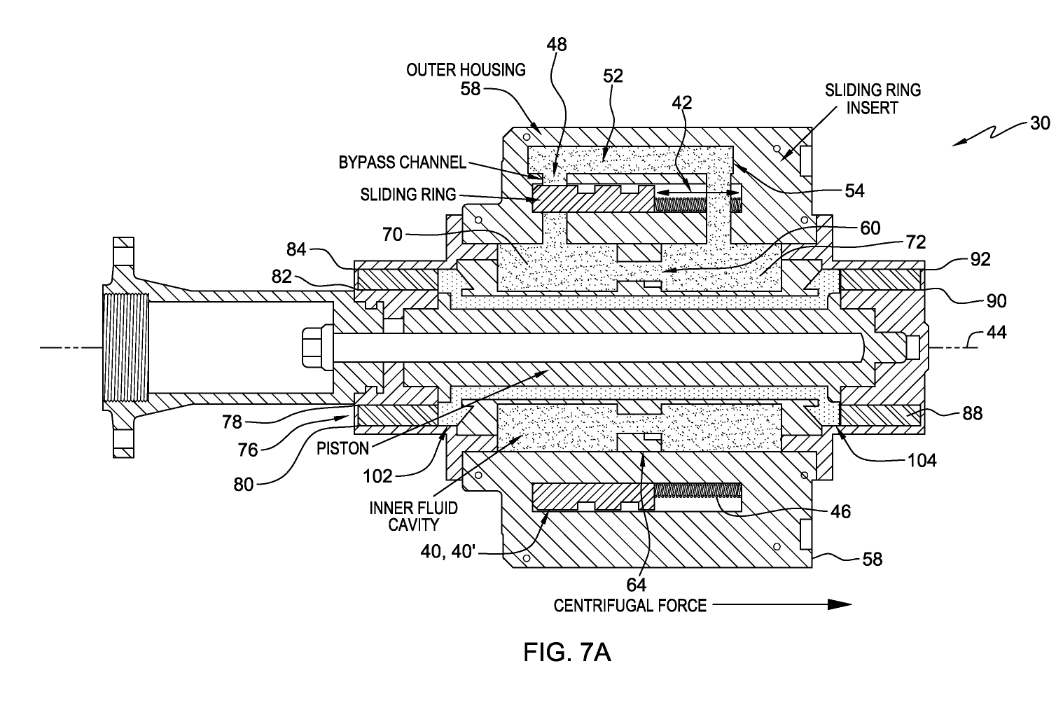

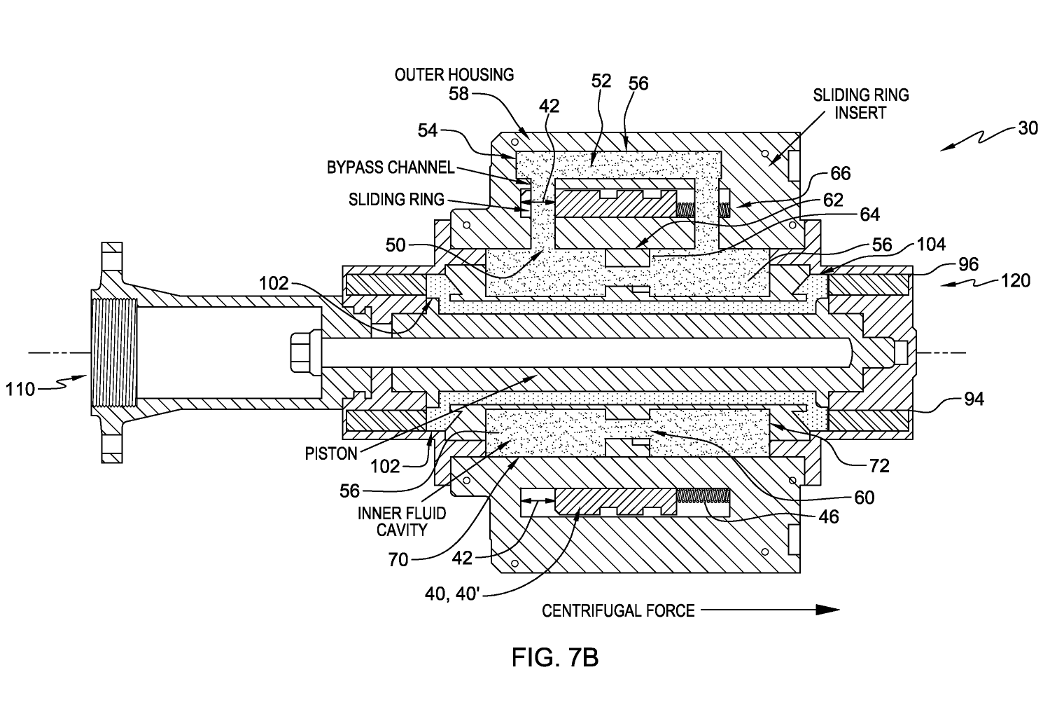

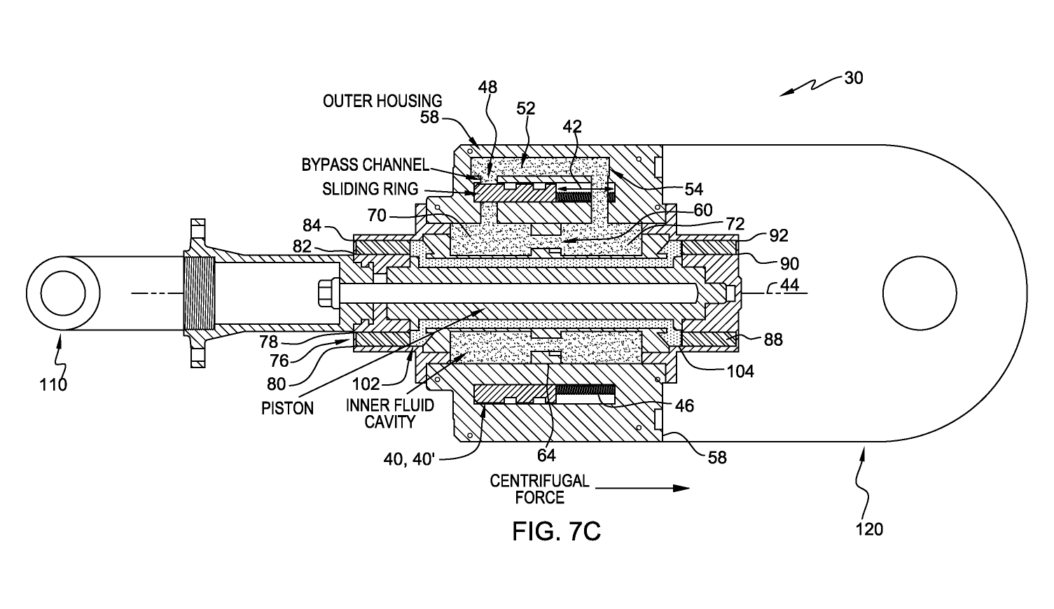

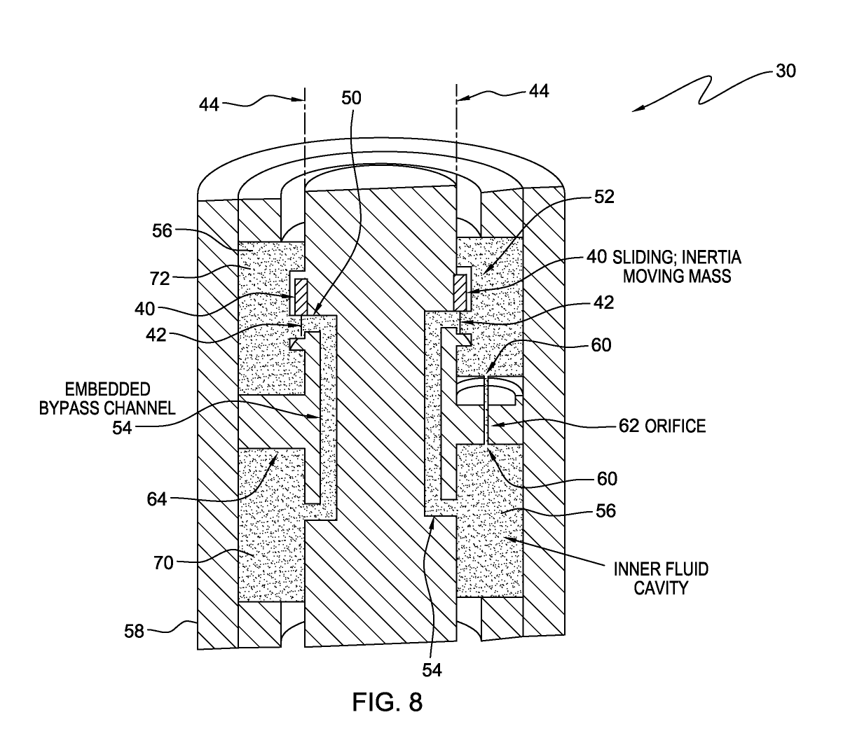

### DETAILED DESCRIPTION

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

Reference will now be made in detail to the present preferred embodiments of the invention, examples of which are illustrated in the accompanying drawings.

In an embodiment, the invention includes a method of controlling troublesome helicopter motions. The method includes providing a helicopter 20 with a rotary wing system 22 with at least a first rotating blade 24 rotating about a rotary wing rotation axis 26, the helicopter 20 having a first troublesome ground resonance motion 100 with the rotary wing system 22 rotating out of flight, such as during ground engagement during takeoffs and landings, and a second troublesome air resonance motion 200 during helicopter 20 flight with an in-flight rotary wing system rotation rate 28 about the rotary wing rotation axis 26. The method includes providing at least a first centrifugal force switching fluid damper 30, the first centrifugal force switching fluid damper 30 having at least a first ground resonance motion damping rate stage and at least a second centrifugally switched air resonance motion damping rate stage, with the damper, having a centrifugal force inertia switch. The method includes orienting the first centrifugal force switching fluid damper 30 in relationship to the rotary wing rotation axis 26 and the first rotating blade 24, wherein an in-flight rotary wing system rotation rate 28 of the first centrifugal force switching fluid damper 30 about the rotary wing rotation axis 26 at the in-flight rotary wing system rotation rate 28 centrifugally switches the first centrifugal force switching fluid damper 30 from the first ground resonance motion damping rate to the second centrifugally switched air resonance motion damping rate. As illustrated, helicopter 20 is a fulltime rotary wing aircraft, utilizing the rotary wing rotor system 22 rotating during takeoff, landing and in-flight. The rotating rotary wing system 22 is powered to rotate during flight while maintaining the orientation of axis 26 with the body of the helicopter as compared to part-time rotary wing aircraft which only rotate their rotary wings part of the time for vertical lift, such as takeoff and landing, and convert to a non-rotating in-flight vertical lift system, such as a tilt rotor vertical takeoff aircraft and/or a fixed wing flying aircraft with non-rotating wings during normal forward flight.

The first ground resonance motion damping rate stage has a first damping rate (FDR). The second centrifugally switched air resonance motion damping rate stage has a second damping rate (SDR) wherein FDR>SDR. Preferably, the range for FDR>SDR is between about 0.5FDR>SDR and about 0.2FDR>SDR, with preferred embodiments being about 0.5 FDR>SDR, about 0.3FDR>SDR, about 0.25FDR≧SDR, and about 0.2FDR≧SDR. The most preferred embodiment being about 0.3FDR>SDR.

In one embodiment, the helicopter 20 has the first troublesome ground resonance motion 100 when engaged with a ground 32 during a takeoff/landing with the rotating blades 24 of the rotor 22 rotating about the rotary wing rotation axis 26 with a rotor frequency at or near the frequency matching the in plane natural frequency of the rotor. The first troublesome ground resonance motion 100 is a ground resonance lead-lag natural frequency motion, with the first centrifugal force switching fluid damper 30 first damping rate FDR providing a higher damping of the frequency matching the in plane natural frequency of the rotor, during lower rotation rates such as during helicopter take offs and landings. The second troublesome air resonance motion 200 is an air resonance lead-lag natural frequency motion, with the first centrifugal force switching fluid damper 30 second damping rate (SDR) providing a lower damping of the 1/Rev lead-lag natural frequency.

In an embodiment, the helicopter 20 has the second troublesome air resonance motion 200 when the helicopter 20 in-flight rotary wing system rotation rate 28 is proximate to and including one of the flight operating frequencies. The helicopter 20 may be a variable speed rotor helicopter 20 with variable flight operating frequencies. As illustrated, the helicopter 20 has the first troublesome ground resonance with an out-of-flight rotary wing rotor system low rotation rate 29, with the first ground resonance motion damping rate stage having the first damping rate (FDR), the second centrifugally switched air resonance motion damping rate stage having the second damping rate (SDR) at the in-flight rotary wing system rotation rate 28, with the high rotation rate 28 greater than the low rotation rate 29 and FDR≧SDR. A preferred range is about 0.5FDR≧SDR to about 0.3FDR≧SDR, and a more preferred range being about 0.3FDR≧SDR.

In preferred embodiments, the first centrifugal force switching fluid damper 30 includes an inertia moving mass 40, with the inertia moving mass 40 having a switch path 42. The inertia moving mass 40 switch path 42 has a movement axis 44 oriented relative to the rotary wing rotation axis 26. The inertia moving mass 40 switch path 42 and its movement axis 44 has a radial component oriented with a radii of the blade 24 and the rotation axis 26. Preferably, the inertia moving mass 40 is a sprung inertia moving mass 40′, or sprung mass 40′. Preferably, the sprung mass 40′ is sprung with a biasing spring 46. Biasing spring 46 forces the sprung mass 40′ towards an obstructing closing position 48 when blade 24 is not rotating. The closing position 48 obstructs a secondary damper orifice 50. Biasing spring 46 is a damper member that provides a spring force to bias the sprung mass 40′ towards its closing position 48. Biasing spring 46 may be a single spring or a plurality of springs. In a preferred embodiment, biasing spring 46 includes a metal spring. In a preferred embodiment, biasing spring 46 includes an elastomer spring.

Preferably, the unobstructed secondary damper orifice 50 provides a secondary less restrictive fluid flow path to provide the second centrifugally switched air resonance motion damping rate stage, with the secondary orifice opening with the centrifugal loading of the first centrifugal force switching fluid damper 30 and the inertial moving mass 40. The centrifugal loading of the inertial moving mass 40 by the in-flight rotary wing system rotation rate 28 centrifugally switches the first centrifugal force switching fluid damper 30 with the obstructing and unobstructing of the secondary damper orifice 50 by the inertial moving mass 40 providing for a centrifugal force switch 52.

Preferably, the first centrifugal force switching fluid damper 30 is a fluid damper with the flow of fluid in the first centrifugal force switching fluid damper 30 providing the first damping rate (FDR) and the centrifugally switched air resonance second damping rate (SDR) with FDR>SDR. The centrifugal force switch 52 switches a damper fluid flow area inside the first centrifugal force switching fluid damper 30, which is related to the damping rate of the first centrifugal force switching fluid damper 30. The in-flight rotary wing system rotation rate 28 unobstructs the secondary damper orifice 50 opening a secondary conduit 54 for the flow of damper fluid 56 to switch the damper fluid flow area inside the first centrifugal force switching fluid damper 30. Preferably, the secondary conduit 54 does not extend out of the damper housing 58.

Preferably, the first centrifugal force switching fluid damper 30 is mechanically switched between the first damping rate stage and the second damping rate stage without electromagnetic power or signals used. The first centrifugal force switching fluid damper 30 is switched between the first damping rate stage and the second damping rate stage without the use of a controller, such as a computer processor or signal processor that utilizes electromagnetic inputs/outputs. Electromagnetic fields are not used to control the first centrifugal force switching fluid damper 30, with the fluid 56 being a non-magnetorheological (MR), non-electrorhelogical (ER) fluid, with the viscosity of fluid 56 not actively controlled with an electromagetic (EM) field (magnetic or electric field) applied to the fluid. Preferably, the damper fluid 56 is a particle free fluid free of suspended particles. The first centrifugal force switching fluid damper 30 is free of sensors. The first centrifugal force switching fluid damper 30 is free of communications with a controller that controls the damping rate. The damper first damping rate (FDR) is provided by damper fluid flow though a first stage damping fluid flow conduit 60. The first stage damper fluid flow conduit 60 has a high fluid flow restriction through the orifice 62, with the first stage damping fluid flow providing the first damping rate (FDR) with fluid flow through at least a first conduit 60, which may be a single first conduit or multiple first conduits that provide the primary fluid flow. In a preferred embodiment, the first stage damping fluid flow conduit 60 is an annular flow through the annulus between the damper piston 64 and the damper housing 58. In a preferred embodiment, the first stage damping fluid flow conduit 60 is a piston conduit flow through the piston 64. The second stage damping fluid flow switching the damper 30 to the second damping rate (SDR) is provided by secondary fluid flow of the damper fluid through a secondary conduit 54 that is opened by the switch 52. The second stage conduit 54 is at least a second fluid flow conduit which may be a single second conduit or multiple second conduits that provide the secondary flow. In preferred embodiments, the second stage conduit 54 is piston conduit flow through the piston 64. In preferred embodiments, the second stage conduit 54 is a bypass conduit flow though a fluid channel outside the piston 64 with the conduit 54 between the piston 64 and the damper housing 58. The second stage conduit may be more than a single conduit with the same or multiple obstructing switch masses 40.

Preferably, the first centrifugal force switching fluid damper 30 provides the helicopter 20 with reduced weight, reduced hub loads and improves the reliability of damper performance in the use of the helicopter. The first centrifugal force switching fluid damper 30 reduces transmitted vibration into the helicopter 20 with reduced helicopter hub loads during helicopter flight that results from the modal response of the blades 24. The first centrifugal force switching fluid damper 30 provides the first damping rate (FDR) at low out of flight rotation rates 29, such as for example a low rotor speed of about 1.7 Hz, and the second centrifugally switched air resonance motion damping rate stage second damping rate (SDR) is switched to at higher in-flight rotation rates 28, such as for example at a helicopter normal operating frequency of about 5 Hz. The first centrifugal force switching fluid damper 30 includes the centrifugal force inertial switch 52 with inertia moving mass 40 reacting against preloaded spring 46, that switches the damper to the second damping rate SDR at the higher in-flight rotation rates 28. With first centrifugal force switching fluid damper 30 disposed and oriented at about 0.75 m from rotation axis 26 of the helicopter 20, the effective mass of a component at 0.0 Hz is M, then the effective mass of the component at 1.7 Hz is 9 M, and then the effective mass of the component at 5.0 Hz is 75 M. The centrifugal force inertial switch 52 provides the first centrifugal force switching fluid damper 30 with centrifugal force dependency. The first centrifugal force switching fluid damper 30 contains a suspended fluid flow inhibitor 66, the suspended fluid flow inhibitor 66 increasing the flow of fluid during the in-flight rotation with the suspended fluid flow inhibitor opening a secondary conduit fluid flow with the increased effective mass generated at the in-flight rotation rate 28 and with the suspended fluid flow inhibitor 66 inhibiting fluid flow through the secondary conduit at the lower out of flight rotation rates 29.

In an embodiment the invention includes a helicopter damper 30 for controlling a first troublesome ground resonance motion 100 during ground engagement and a second troublesome air resonance motion 200 during helicopter flight. The helicopter damper 30 has a first high damping rate (FDR) for controlling the first troublesome ground resonance motion 100 and a second low damping rate (SDR) for controlling the second troublesome air resonance motion 200. The second low damping rate (SDR) is less than the first high damping rate (FDR).

The helicopter damper 30 includes a centrifugal force switch 52, wherein an in-flight rotation 28 of the helicopter damper centrifugal force switch 52 reduces the first high damping rate FDR down to the second low damping rate (SDR). The helicopter damper 30 preferably, has a first variable volume fluid working chamber 70 and a second variable volume fluid working chamber 72. The variable volume fluid working chamber 70 and a second variable volume fluid working chamber 72 have a first damping fluid flow conduit 60 that provide first damping fluid flow for damper fluid 56 between the first variable volume fluid working chamber 70 and the second variable volume fluid working chamber 72.

The first variable volume fluid working chamber 70 and the second variable volume fluid working chamber 72 are provided with variable volumes by a damper piston 64 in a damper housing 58. Damper housing 58 separates the two variable volume fluid working chambers. A motion of the damper piston 64 relative to the damper housing 58 reduces the volume of one fluid working chamber while increasing the volume of the other working chamber.

The damper piston 64 and housing 58 are oriented and attached to the helicopter between the helicopter blade 24 and the rotation axis 26 such that the troublesome relative motion of the blade relative to the helicopter hub and axis 26 generates the motion of the damper piston 64 relative to the damper housing 58 and works the fluid back and forth between the two variable volume fluid working chambers. The first damping fluid flow conduit 60 preferably, provides a high restriction to fluid flow to provide the first high damping rate (FDR).

The helicopter damper 30 includes a second damping fluid flow conduit 54 between the first variable volume fluid working chamber 70 and the second variable volume fluid working chamber 72, wherein the centrifugal force switch 52 opens a reduced resistance fluid flow path between the first variable volume fluid working chamber 70 and the second variable volume fluid working chamber 72 through the second damping fluid flow conduit 54, with the low restriction fluid flow through the conduits providing the second low damping rate (SDR).

The helicopter damper 30 includes a volume compensator 74, with the volume compensator 74 distal from the centrifugal force switch 52. The volume compensator is distal from the centrifugal force switch's moving mass 40 and the fluid working chambers 70,72, with the volume compensator 74 dynamically isolated from the fluid working chambers 70,72, the fluid flow conduits 54, 60, and the fluid pressures generated in such. The centrifugal force switch 52 and the centrifugal force switch's moving mass 40 are proximate the working chambers 70, 72.

Preferably, the range for FDR>SDR is between about 0.5FDR>SDR and about 0.2FDR>SDR, with preferred embodiments being about 0.5 FDR>SDR, about 0.3FDR>SDR, about 0.25FDR≧SDR, and about 0.2FDR≧SDR. The in-flight rotation rate 28 is an in-flight rotary wing system rotation rate proximate to and including one of the flight operating frequencies of the helicopter, with rotation rate 28 higher than the lower out of flight rotation rate 29. The centrifugal force switch 52 includes inertia moving mass 40, with the inertia moving mass 40 having a switch path 42. The inertia moving mass switch path 42 having a movement axis 44, with the movement axis 44 oriented relative to the rotary wing rotation axis 26. The switch path 42 intersects the second conduit fluid flow path through the secondary conduit 54. The centrifugal force switch 52 includes a biasing spring 46 connected with a mass 40′. The biasing spring 46 forces the sprung mass 40′ towards a closing position 48 when the blade 24 is not rotating around the axis 26, with the closing position 48 closing the secondary damper orifice 50. The biasing spring 46 biases the mass 40′ to close the secondary fluid flow orifice 50 during the lower out of flight rotation rate 29, with the in-flight rotation of damper 30 around the rotary wing rotation axis 26 at the higher in-flight rotation rate 28 compressing the biasing spring 46.

In an embodiment, the invention includes a damper 30. The damper 30 includes a first variable volume fluid working chamber 70 and a second variable volume fluid working chamber 72. The first variable volume fluid working chamber 70 and the second variable volume fluid working chamber 72 have a first damping fluid flow conduit 60 providing a first damping fluid flow between the first variable volume fluid working chamber 70 and the second variable volume fluid working chamber 72. The damper 30 includes a second damping fluid flow conduit 54 between the first variable volume fluid working chamber 70 and the second variable volume fluid working chamber 72. The damper 30 includes a biased mass 40′, wherein the biased mass 40′ is biased to obstruct a second damping fluid flow through the second damping fluid flow conduit 54 at a first low speed rotation 29 about an axis 26, and a second high speed rotation 28 about the axis 26 moves the biased mass 40′ to unobstruct the second damping fluid flow through the second damping fluid flow conduit 54.

The damper 30 includes a volume compensator 74, the volume compensator 74 distal from the biased mass 40′. The volume compensator 74 is distal from the fluid working chambers 70,72 with the volume compensator 74 dynamically isolated from the fluid working chambers 70,72 and the fluid flow conduits 54, 60 and the fluid pressures generated in the chambers 70,72 and the conduits 54, 60 during working of the chambers 70,72. The biased mass 40′ is proximate the working chambers 70, 72. The damper 30 has a first high damping rate (FDR) when the biased mass 40′ obstructs the second damping fluid flow through the second damping fluid flow conduit 54, and the damper 30 has a second low damping rate (SDR) with the second damping fluid flow through the second damping fluid flow conduit 54, with FDR>SDR. Preferably, the range for FDR>SDR is between about 0.5FDR>SDR and about 0.2FDR>SDR, with preferred embodiments being about 0.5 FDR>SDR, about 0.3FDR>SDR, about 0.25FDR≧SDR, and about 0.2FDR≧SDR.

The second high speed rotation rate 28 about the axis 26 is greater than the first low speed rotation 29. The biased mass 40′ has a movement path 42 proximate the second damping fluid flow conduit 54. The movement path 42 has a movement axis 44, with the movement axis oriented relative to the rotation axis 26. The second damping fluid flow conduit 54 is an internal damper fluid flow conduit. The second damping fluid flow conduit 54 does not extend out of the damper housing 58, with the conduit inside the damper 30. The second damping fluid flow conduit 54 is proximate the working chambers 70, 72, with the conduit not extending out away from the damper housing 58.

The damper housing 58 has a damper housing outer perimeter, having an outside diameter (OD) centered around the damper longitudinally extending axis, with the conduits inside the outer perimeter and not extending outside the outer perimeter. The biased mass 40′ is biased with a spring 46. The damper 30 includes a first bonded elastomer seal 76 having an inner bonded elastomer interface 78 and an outer bonded elastomer interface 80. Elastomer seal 76 has non-moving seal interfaces 78, 80 with the elastomer bonded to nonelastomer damper interface inner and outer members 82, 84, with the seal 76 containing fluid 56 within the damper 30. The fluid 56 is contained inside damper 30 without a moving seal interface, such as a moving seal interface of an O-ring or piston rod wiping seal.

In a preferred embodiment, the elastomer seal 76 has a nonelastomer shim 86 between the non-moving seal interfaces 78, 80. The damper 30 includes a second bonded elastomer seal 88 having an inner bonded elastomer interface 90 and an outer bonded elastomer interface 92. The non-moving seal interfaces of the elastomer are bonded to nonelastomer damper interface inner member 94 and outer member 96, with the seal 88 containing fluid 56 within the damper 30 and containing the fluid inside the damper without moving seal interfaces.

Damper 30 includes a first outer nonworking fluid chamber 102 and a second outer nonworking fluid chamber 104. The first outer nonworking fluid chamber 102 is between the first variable volume fluid working chamber 70 and the first bonded elastomer seal 76. The second outer nonworking fluid chamber 104 is between the second variable volume fluid working chamber 104 and the second bonded elastomer seal 88. The nonworking fluid chambers 102, 104 are not directly exposed to the working fluid flows and pressures of the damper fluid 56 in the working chambers 70, 72 and the first and second damping fluid flow conduits 60, 54. The nonworking fluid chambers 102, 104 are preferably distal from the first and second damping fluid flow conduits 60, 54. The bonded elastomer seals 76, 88 are distal from the first and second damping fluid flow conduits 60, 54. The elastomer seals 76, 88 with their bonded non moving seal interfaces contain the fluid inside the housing 58, with the working chambers 70,72 distal from the elastomer seals 76, 88. The nonworking fluid chambers 102, 104 surround the working chambers and provide and bathe the working chambers with a supply of damper fluid to work on.

Preferably, damper 30 is for use in controlling motion in a rotating machine 23 rotating about a rotating machine axis 26′, in a manner with the biased mass 40′ biased in a direction towards the rotating machine axis 26′. The spring 46 biasing the mass 40 inward towards the rotating machine axis 26′.

Preferably, damper 30 is for use in controlling motion in a helicopter 20, in a manner with the biased mass 40′ biased in a direction towards a rotary wing rotation axis 26 of the helicopter 20. The spring 46 biasing the mass 40 inward towards axis 26 with the second damping fluid flow obstructed when the helicopter 20 is not airborne and is unobstructed when the helicopter 20 is in-flight.

In an embodiment, the invention includes a method of making a damper 30 having an inboard end 110 and an outboard end 120. The method includes providing a first variable volume fluid working chamber 70 and a second variable volume fluid working chamber 72. A first damping high restriction fluid flow conduit 60 is between the first variable volume fluid working chamber 70 and the second variable volume fluid working chamber 72. A second damping low restriction fluid flow conduit 54 is between the first variable volume fluid working chamber 70 and the second variable volume fluid working chamber 72.

The method includes providing a mass 40 and a spring 46. The method includes orienting the mass 40 and the spring 46 between the inboard end 110 and the outboard end 120. The outboard end 120 is proximate the second damping fluid flow conduit 54, wherein the second damping fluid flow conduit 54 is obstructed with the spring 46 biasing the mass 40 towards the inboard end 110. A rotation of the damper 30 about an axis 26 proximate the inboard end 110 unobstructs the second damping fluid flow conduit 54. The mass 40 is biased to obstruct second damping fluid flow through the second damping fluid flow conduit 54 at a first low speed rotation 29 about axis 26, and a second high speed rotation 28 about the axis 26 moves the biased mass 40 to unobstruct the second damping fluid flow through the second damping fluid flow conduit 54.

The method includes providing a damper fluid volume compensator 74, and disposing the damper fluid volume compensator 74 distal from the mass 40. The volume compensator 74 is distal from the working chambers 70, 72. The volume compensator 74 is distal from the moving mass 40 and the obstructed conduit 54. The volume compensator 74 is dynamically isolated from the working chambers 70, 72 and the fluid flow conduits 54, 60. The mass 40 is proximate the working chambers 70, 72. The damper 30 has a first high damping rate (FDR) when the second damping fluid flow conduit 54 is obstructed at a low rotor speed. The damper 30 also has a second low damping rate (SDR) with the second damping fluid flow conduit unobstructed, with FDR>SDR. Preferably, with a high rotor speed rotation 28 about the axis 26 proximate an operating frequency, the damper 30 has the second low damping rate SDR with the second damping fluid flow conduit 54 unobstructed. Preferably, the range for FDR>SDR is between about 0.5FDR>SDR and about 0.2FDR>SDR, with preferred embodiments being about 0.5 FDR>SDR, about 0.3FDR>SDR, about 0.25FDR≧SDR, and about 0.2FDR≧SDR.

The mass 40 has a movement path 42 proximate the second damping fluid flow conduit 54, with the mass 40 moving in an outboard direction by the rotation. The second damping fluid flow conduit 54 is an internal damper fluid flow conduit inside the damper 30. The conduit 54 does not extend out of the damper housing 58. The second damping fluid flow conduit 54 is proximate the working chambers 70, 72.

The method includes providing a first bonded elastomer seal 76 having an inner bonded elastomer interface 78 bonded to an inner nonelastomer damper interface inner member 82 and an outer bonded elastomer interface 80 bonded to an outer nonelastomer damper interface outer member 84, and containing damper fluid 56 in the damper 30 with the first bonded elastomer seal 76. The method includes providing a second bonded elastomer seal 88 having an inner bonded elastomer interface 90 bonded to an inner nonelastomer damper interface inner second member 94 and an outer bonded elastomer interface 92 bonded to an outer nonelastomer damper interface outer second member 96, and containing the damper fluid 56 in the damper 30 with the second bonded elastomer seal 88. The damper fluid 56 is contained inside the damper housing 58 with the bonded elastomer seals 76, 88, with the fluid 56 contained inside the damper without moving unbonded seal interfaces.

The method includes providing a first outer nonworking fluid chamber 102 and a second outer nonworking fluid chamber 104. The first outer nonworking fluid chamber 102 is between the first inner variable volume fluid working chamber 70 and the first bonded elastomer seal 76. The second outer nonworking fluid chamber 104 is between the second inner variable volume fluid working chamber 72 and the second bonded elastomer seal 88. The nonworking fluid chambers 102,104 are not directly exposed to the working fluid flows and pressures of the inner working chambers 70, 72 and the first and second damping fluid flow conduits 60, 54. The nonworking fluid chambers 102,104 are distal from the conduits 60, 54, and the elastomer seals 76, 88 are distal from the conduits 60, 54. The first bonded elastomer seal 76 is proximate the inboard end 110 and the second bonded elastomer seal 88 is proximate the outboard end 120.

In an embodiment, the invention includes a machine 23. The machine 23 includes a rotary system 22 rotating about a rotation axis 26′. The machine has a first motion during rotation about the rotation axis 26′ at a first low rotation rate and a second motion during rotation about the rotation axis 26′ at a second high rotation rate.

The machine includes a centrifugal force switching fluid damper 30. The centrifugal force switching fluid damper 30 having a first motion damping rate stage and a second motion centrifugally switched damping rate stage switched with a centrifugal force inertia switch 52. The centrifugal force switching fluid damper 30 is oriented relative to the rotation axis 26′ wherein the second high rotation rate centrifugally switches the centrifugal force switching fluid damper 30 from the first motion damping rate stage to the second motion centrifugally switched damping rate stage with the second motion centrifugally switched damping rate stage damping the second motion. The centrifugal force switching fluid damper 30 includes a first variable volume fluid working chamber 70 and a second variable volume fluid working chamber 72. A first damping fluid flow high restriction conduit 60 is between the first variable volume fluid working chamber 70 and the second variable volume fluid working chamber 72. A second damping fluid flow low restriction conduit 54 is between the first variable volume fluid working chamber 70 and the second variable volume fluid working chamber 72, a mass 40, and a spring 46, with the mass 40 and the spring 46 proximate the second damping fluid flow conduit 54. The second damping fluid flow conduit 54 is obstructed with the spring 46 biasing the mass 40 towards the rotation axis 26′, and the second high rotation rate unobstructs the second damping fluid flow conduit 54.

The damper 30 has a first high damping rate (FDR) when the second damping fluid flow conduit 54 is obstructed. The damper 30 has a second low damping rate SDR with the second damping fluid flow conduit 54 unobstructed, with FDR>SDR. Preferably, the range for FDR>SDR is between about 0.5FDR>SDR and about 0.2FDR>SDR, with preferred embodiments being about 0.5 FDR>SDR, about 0.3FDR>SDR, about 0.25FDR≧SDR, and about 0.2FDR≧SDR.

The second high rotation rate 28 is proximate a machine operating frequency and the first low rotation rate 29 is at a below operating frequency of the machine. The mass 40 has a movement path 42 proximate the second damping fluid flow conduit 54, with the mass 40 moved in an outboard direction by the rotation. The second damping fluid flow conduit 54 is an internal damper fluid flow conduit that does not extend out of the damper housing 58. The centrifugal force switching fluid damper 30 includes a first bonded elastomer seal 76 having an inner bonded elastomer interface 78 bonded to an inner nonelastomer damper interface inner member 82, and an outer bonded elastomer interface 80 bonded to an outer nonelastomer damper interface outer member 84, and the centrifugal force switching fluid damper 30 contains damper fluid 56 in the damper 30 with the first bonded elastomer seal 76. The centrifugal force switching fluid damper 30 includes a second bonded elastomer seal 88 having an inner bonded elastomer interface 90 bonded to an inner nonelastomer damper interface inner second member 94, and an outer bonded elastomer interface 92 bonded to an outer nonelastomer damper interface outer second member 96. The centrifugal force switching fluid damper 30 contains the damper fluid 56 in the damper 30 with the first and the second bonded elastomer seals 76,88.

The centrifugal force switching fluid damper 30 includes a first outer nonworking fluid chamber 102 and a second outer nonworking fluid chamber 104. The first outer nonworking fluid chamber 102 is between the first variable volume fluid working chamber 70 and the first bonded elastomer seal 76. The second outer nonworking fluid chamber 104 is between the second variable volume fluid working chamber 72 and the second bonded elastomer seal 88. The nonworking fluid chambers 102,104 are not directly exposed to working fluid flows and pressures of the working chambers and the first and second damping fluid flow conduits. The first bonded elastomer seal 76 is proximate the inboard end 110 and the second bonded elastomer seal 88 is proximate the outboard end 120. The machine 23 is for use in controlling motion in a helicopter 20. In a manner with the rotary system 22 rotating about the helicopter rotary wing rotation axis 26 with the first motion during rotation about the rotation axis 26 at a first low rotation rate 29 is a troublesome helicopter ground resonance motion 100, and the second motion during rotation about the rotation axis at a second high rotation rate 28 is a troublesome helicopter air resonance motion 200. The spring 46 biases the mass 40 inward towards the rotary wing axis 26, with the second damping fluid flow obstructed when the helicopter 20 is not airborne and is unobstructed by the rotation about the axis 26 when the helicopter 20 is in-flight.

In an embodiment, the invention includes a process. The process includes providing a helicopter rotor 25 which rotates about a helicopter axis of rotation 26. The process includes providing a rotation rate switched fluid damper 30 containing a damper fluid 56 in a fluid damper housing 58. The rotation rate switched damper and housing having an inboard end 110 and an outboard end 120. The process includes orienting the rotation rate switched fluid damper 30 with the inboard end 110 proximate the helicopter axis of rotation 26 and the outboard end 120 distal from the helicopter axis of rotation 26 wherein a helicopter out of flight low speed rotation 29 of the helicopter rotor 25 and the oriented rotation rate switched fluid damper 30, provides a first damping rate (FDR). A helicopter in-flight rotation 28 of the helicopter rotor 25 and the oriented rotation rate switched fluid damper 30 provides a second damping rate (SDR) with FDR>SDR. Preferably, the range for FDR>SDR is between about 0.5FDR>SDR and about 0.2FDR>SDR, with preferred embodiments being about 0.5 FDR>SDR, about 0.3FDR>SDR, about 0.25FDR≧SDR, and about 0.2FDR≧SDR.

Preferably, the helicopter in-flight rotation is higher than the first low speed rotation 29. The rotation rate switched fluid damper 30 includes an inertia moving mass 40, with the inertia moving mass 40 having a switch path 42 within the damper housing 58. The inertia moving mass 40 is a sprung mass 40′ with a biasing spring 46 forcing the mass towards a closing position 48 when the blade 24 is not rotating, with the closing position 48 closing a damper orifice 50.

The rotation rate switched fluid damper 30 includes a suspended fluid flow inhibitor 66, the suspended fluid flow inhibitor 66 increasing the flow of damper fluid during the in-flight rotation 28. The rotation rate switched fluid damper 30 contains a first variable volume fluid working chamber 70 and a second variable volume fluid working chamber 72. A first damping fluid flow conduit 60 is between the first variable volume fluid working chamber and the second variable volume fluid working chamber. A second damping fluid flow conduit 54 is between the first variable volume fluid working chamber and the second variable volume fluid working chamber.

The rotation rate switched fluid damper 30 contains a mass 40 and a spring 46 between the inboard end 110 and the outboard end 120. The mass 40 is proximate the second damping fluid flow conduit 54, wherein the second damping fluid flow conduit is obstructed with the spring 46 biasing the mass 40 towards the inboard end 110. The helicopter in-flight rotation unobstructs the second damping fluid flow conduit 54. The damper fluid 56 does not flow outside the housing 58. The second damping fluid flow conduit 54 is an internal damper fluid flow conduit that does not extend out of the damper housing 58.

The rotation rate switched fluid damper 30 includes a first bonded elastomer seal 76 having an inner bonded elastomer interface 78 bonded to an inner nonelastomer damper interface inner member 82, and an outer bonded elastomer interface 80 bonded to an outer nonelastomer damper interface outer member 84 with the seal 76 sealing the housing 58 and containing the fluid 56 in the damper 30. The rotation rate switched fluid damper 30 includes a second bonded elastomer seal 88 having an inner bonded elastomer interface 90 bonded to an inner nonelastomer damper interface inner second member 94, and an outer bonded elastomer interface 92 bonded to an outer nonelastomer damper interface outer second member 96, with the damper 30 containing the damper fluid 56 in the damper with the first and second bonded elastomer seals and without moving seal interfaces.

The rotation rate switched fluid damper 30 includes a first outer nonworking fluid chamber 102 and a second outer nonworking fluid chamber 104. The first outer nonworking fluid chamber 102 is between a first variable volume fluid working chamber 70 and the first bonded elastomer seal 76. The second outer nonworking fluid chamber 104 is between a second variable volume fluid working chamber 72 and the second bonded elastomer seal 88. The nonworking fluid chambers are not directly exposed to working fluid flows and pressures of the working chambers and the first and second damping fluid flow conduits. The nonworking fluid chambers and the elastomer seals are distal from the conduits 60, 54 and the working chambers 70, 72. The first bonded elastomer seal 76 is proximate the inboard end 110 and the second bonded elastomer seal 88 is proximate the outboard end 120.

Preferably, the rotation rate switched fluid damper 30 is not electromagnetically switched. The rotation rate switched fluid damper 30 is mechanically switched with a mechanical centrifugal force switch 52. The rotation rate switched fluid damper 30 is not switched with electromagnetic outputs from an electromagnetic controller. Computer controlled switching is not used to adjust the fluid damper damping rates. An electromagnetic field is not used to vary and change the viscosity of the fluid 56. The fluid 56 is a non-MR non-ER damper fluid.

Modeling and Test

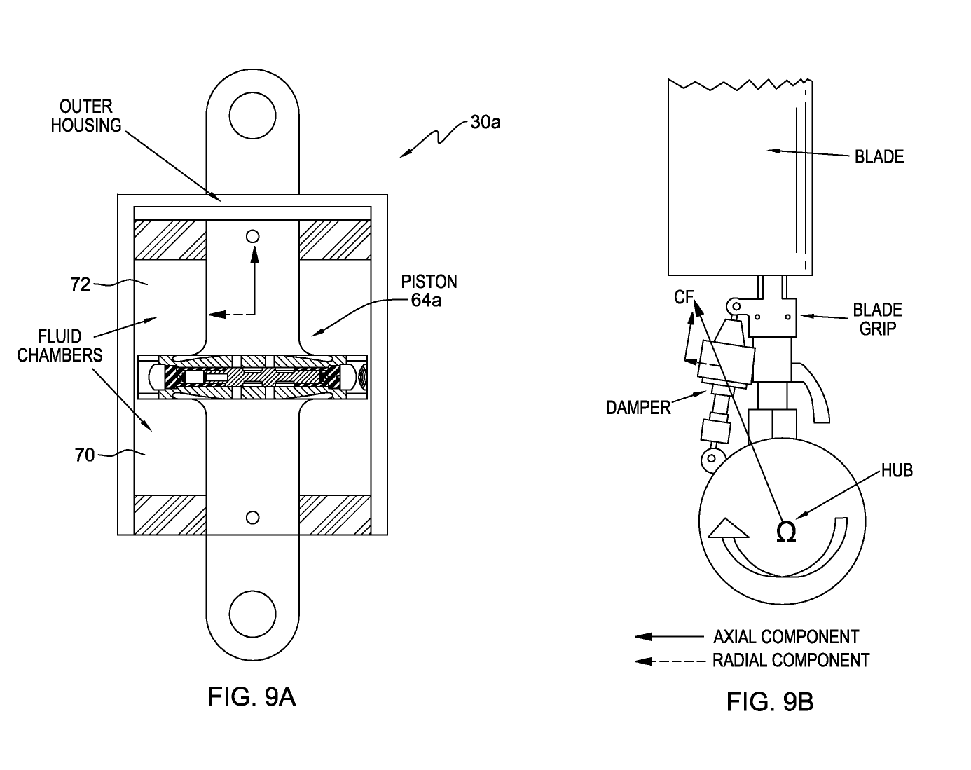

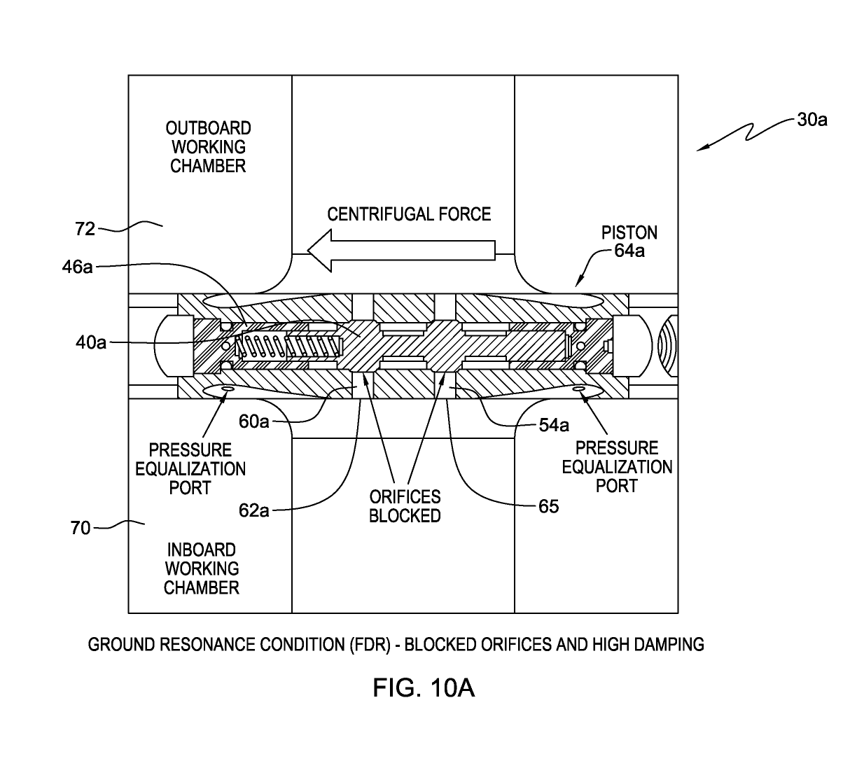

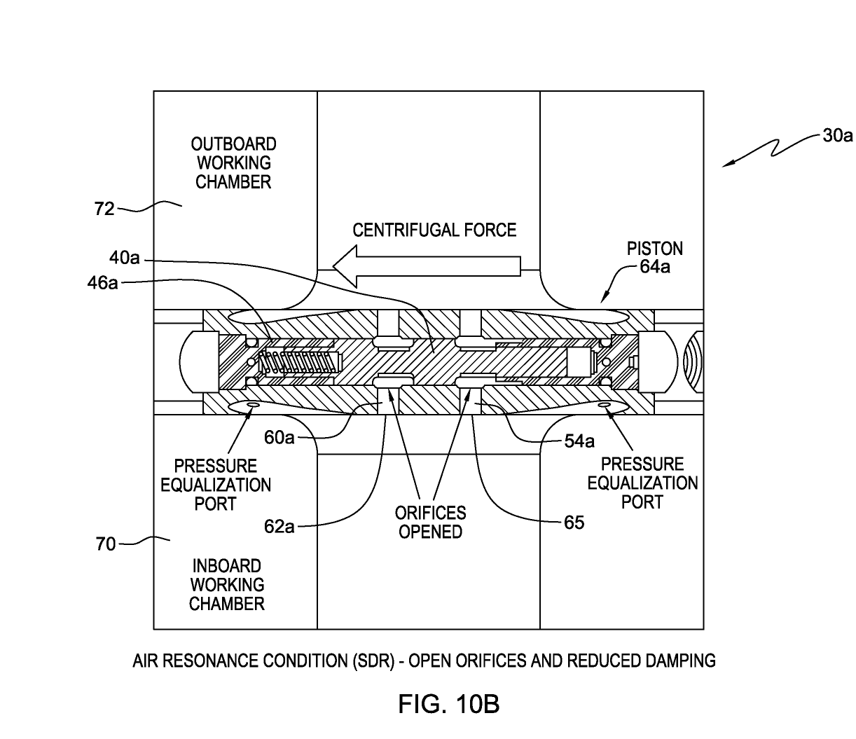

Referring to FIGS. 9-17, section views and CFD modeling of the performance of the inventive damper are illustrated. Referring in particular to FIGS. 10A and 10B, an alternate embodiment of the lead-lag damper 30a illustrates an inertial mass 40a positioned within piston 64a and held by a restraining spring 46a that will change location from FDR to SDR, thereby opening secondary orifices 50a to reduce system damping at SDR. The inertial mass 40a uses the radial component of the Centrifugal Force (CF) to change position from FDR to SDR as illustrated in FIG. 9B. The radially sliding inertial mass 40a is capable of opening multiple secondary orifices. The reduction in damping from FDR to SDR is highly customizable based on the size and number of the secondary orifices.

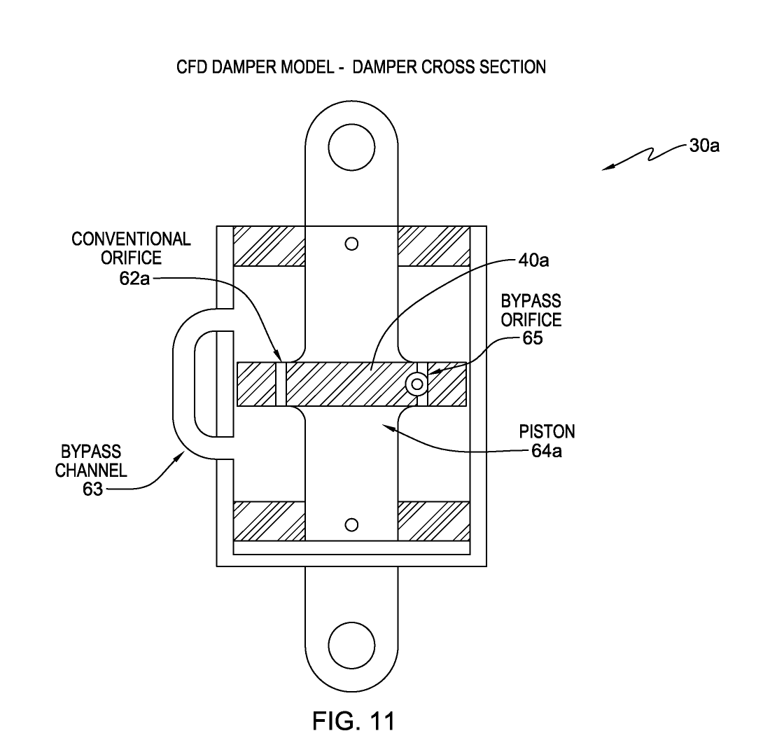

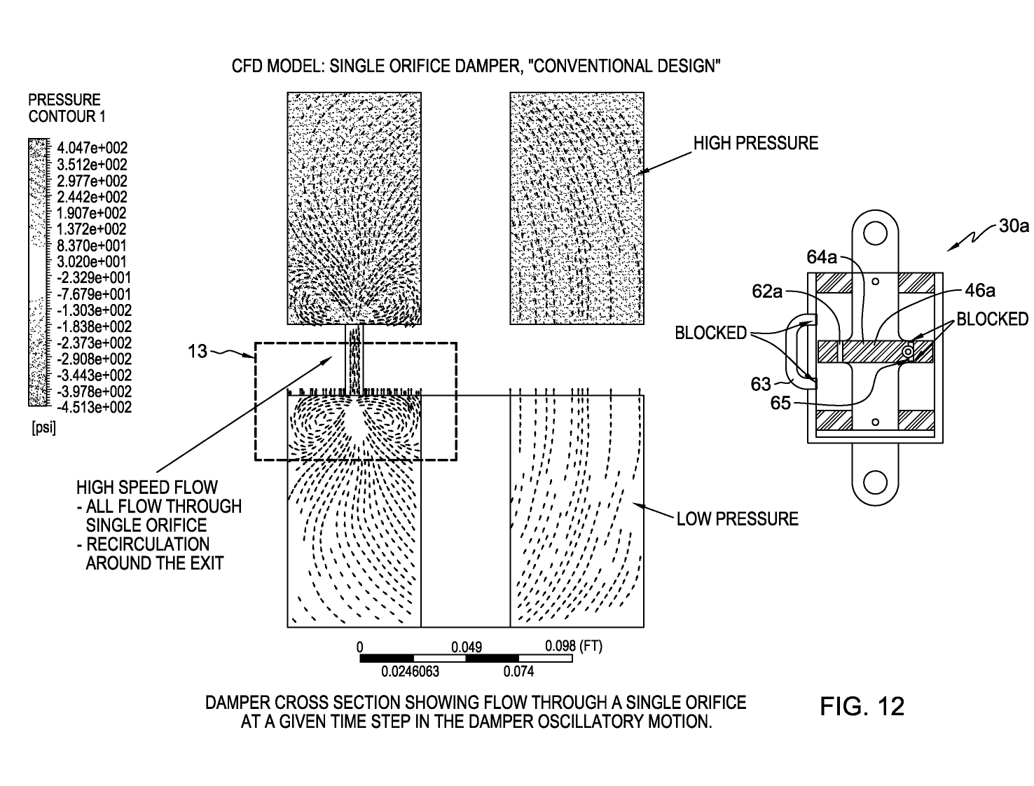

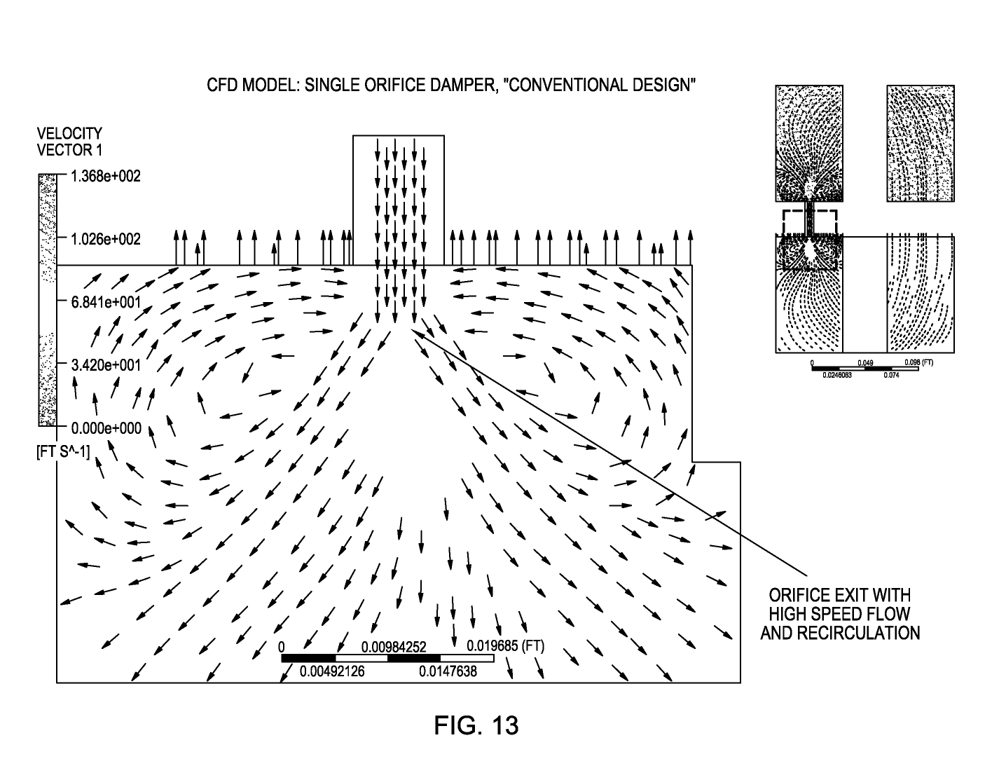

Referring to FIGS. 11-17, the alternate embodiment of the lead-lag damper 30a is illustrated as a computational fluid dynamic (CFD) cross section model. In FIG. 11, a conventional orifice 62a, a bypass channel 63 and a bypass secondary orifice 65 are illustrated. The conventional orifice 62a is associated with first damping fluid flow conduit 60a. The bypass secondary orifice 65 is associated with second damping fluid flow conduit 54a. FIG. 12 illustrates the condition with the conventional orifice 62a open and both the bypass channel 63 and the bypass secondary orifice 65 being blocked. The flow from the high-pressure chamber to the low pressure chamber creates recirculation around the conventional orifice 62a exit. FIG. 13 provides a detail view of the recirculation around the conventional orifice 62a exit.

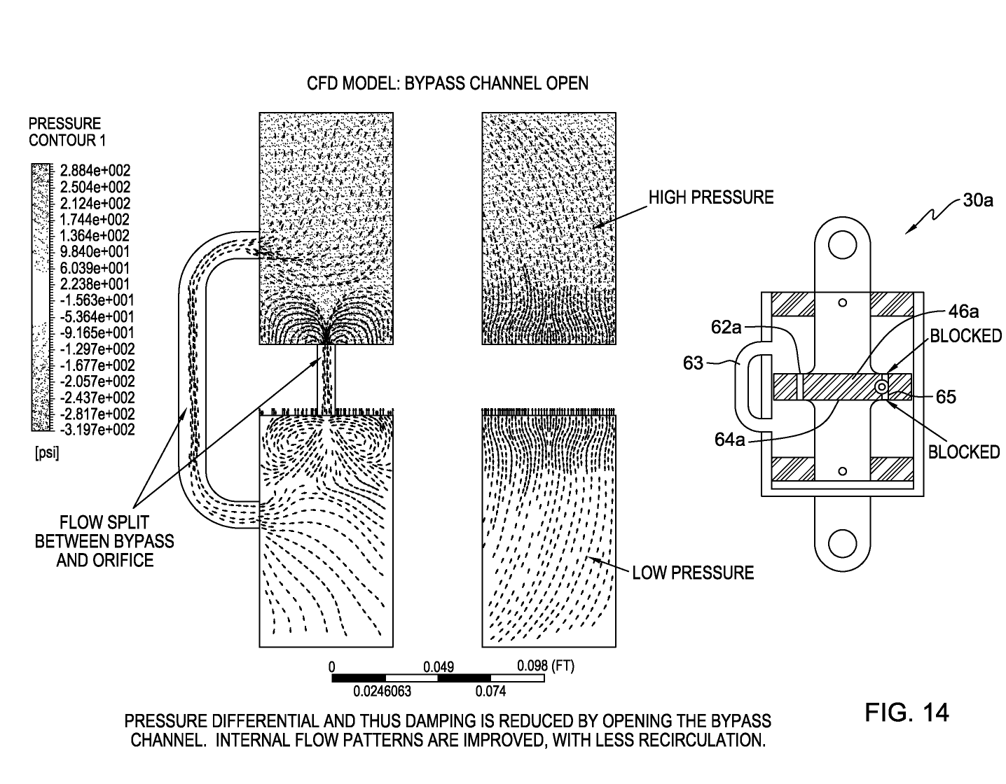

Referring to FIG. 14, the condition with both the conventional orifice 62a and the bypass channel 63 open and the bypass secondary orifice 65 being blocked is illustrated. The flow from the high-pressure chamber to the low pressure chamber creates an improved flow pattern having less recirculation. The damping is reduced with this configuration.

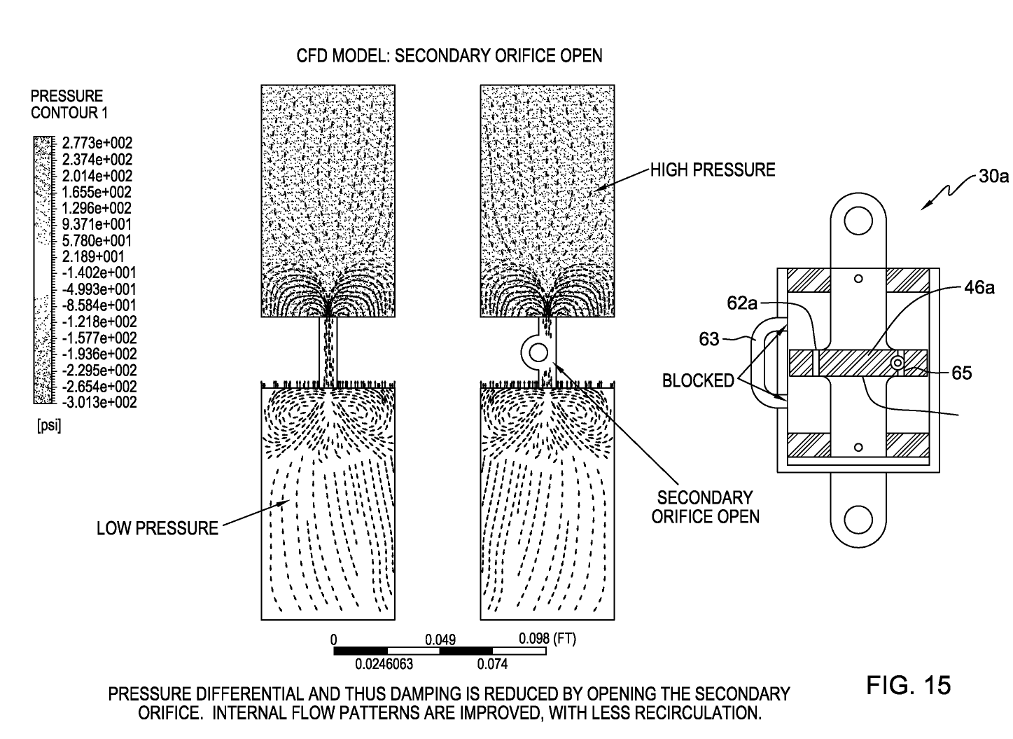

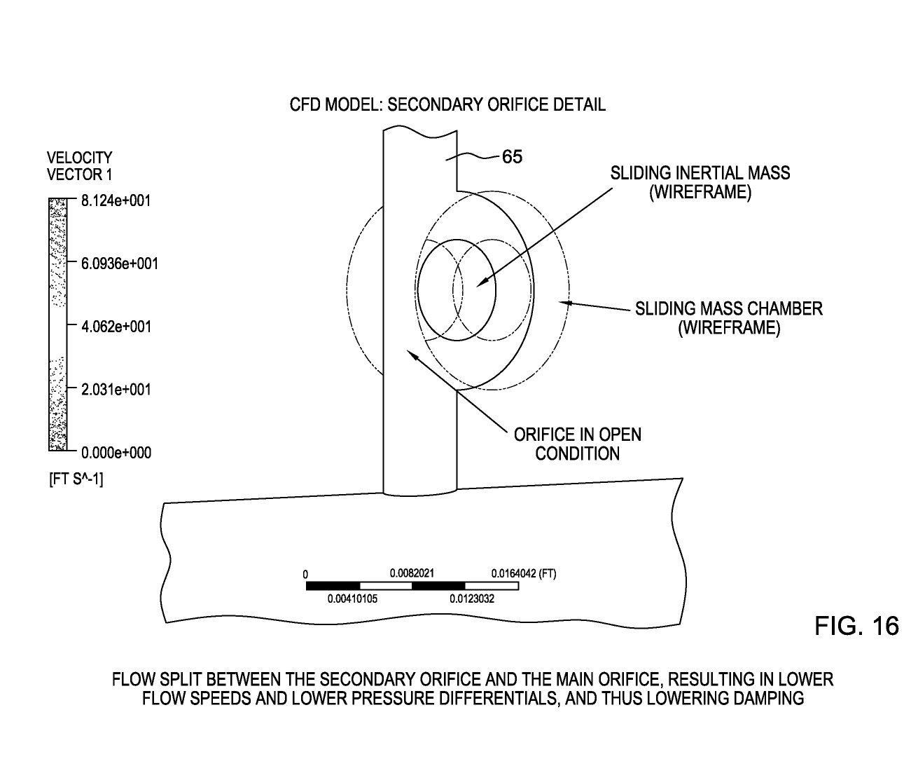

Referring to FIG. 15, the condition with both the conventional orifice 62a and the bypass secondary orifice 65 open and the bypass channel 63 being blocked is illustrated. In this model the flow from the high-pressure chamber to the low pressure chamber also creates an improved flow pattern having less recirculation. The damping is also reduced with this configuration. Referring to FIG. 16, a detail view of the bypass secondary orifice 65 with a wire diagram of the radially sliding inertial mass 40a superimposed thereon is presented. In this model image, the flow is split between the bypass secondary orifice 65 and the main conventional orifice 62a, resulting in lower flow speeds and lower pressure differentials, which provides for lower damping.

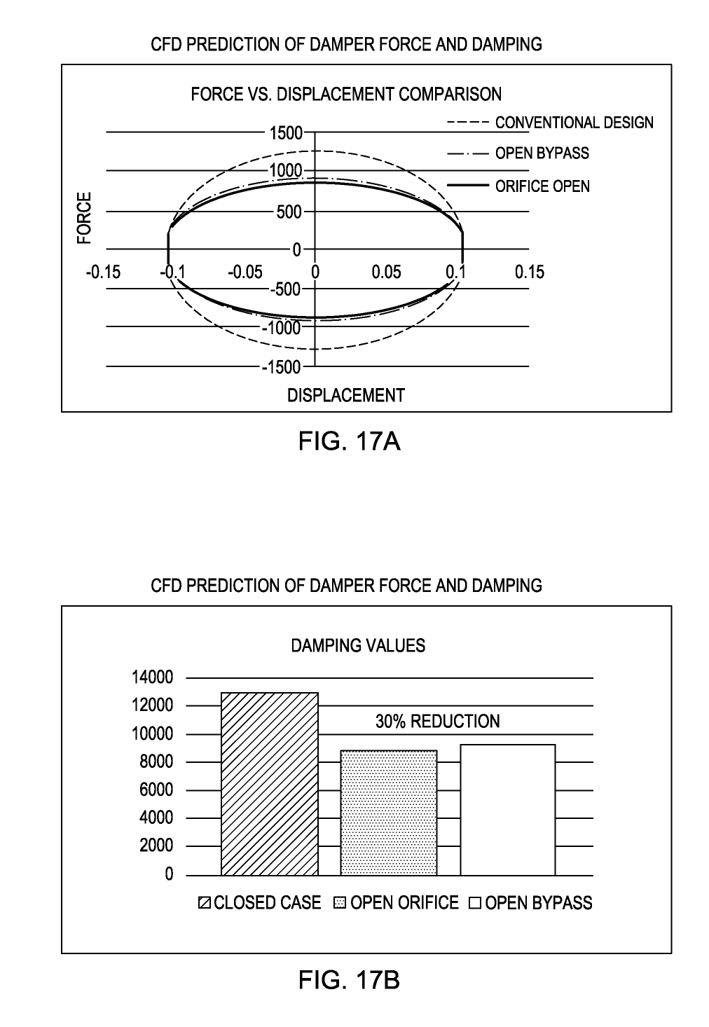

FIG. 17A illustrates the CFD results for the force versus displacement for lead-lag damper 30a using the different orifices. FIG. 17B illustrates the CFD reduced damping value for lead-lag damper 30a using the different orifices. The CFD analysis provides that opening either the bypass channel 63 or the bypass secondary orifice 65 results in approximately a 30% reduction in damping for the specified bypass channel diameter and bypass secondary orifice diameter.

The lead-lag damper 30a comprises a first variable volume fluid working chamber 70 a second variable volume fluid working chamber72. A first damping fluid flow conduit 60a is disposed between the first variable volume fluid working chamber 70 and the second variable volume fluid working chamber 72. A second damping fluid flow conduit 54a between the first variable volume fluid working chamber 70 and the second variable volume fluid working chamber 72. The lead-lag damper 30a includes a piston 64a and an inertial mass 40a positioned within the piston 64a. The lead-lag damper 30a includes a restraining spring 46a, wherein the restraining spring 46a is positioned to exert a bias force on inertial mass 40a to obstruct second damping fluid flow conduit 54a at a first low speed rotation about an axis, and wherein the inertial mass 40a is capable of overcoming the bias force of the restraining spring 46a and unobstruct the second damping fluid flow conduit 60a at a second high speed rotation about the axis.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

We claim:

1. A method of controlling troublesome helicopter motions, said method comprising:
providing a helicopter with a rotary wing system with at least a first rotating blade rotating about a rotary wing rotation axis, said helicopter having a first troublesome ground resonance motion and a second troublesome air resonance motion during helicopter flight with an in-flight rotary wing system rotation rate about said rotary wing rotation axis;
providing at least a first centrifugal force switching damper, said first centrifugal force switching damper having at least a first ground resonance motion damping rate stage and at least a second air resonance motion damping rate stage; and
orienting said first centrifugal force switching damper in relationship to said rotary wing rotation axis and said first rotating blade, wherein an in-flight rotation of said first centrifugal force switching damper about said rotary wing rotation axis centrifugally switches said first centrifugal force switching damper from said first ground resonance motion damping rate to said second air resonance motion damping rate.

2. A method as claimed in claim 1, with said first ground resonance motion damping rate stage having a first damping rate FDR, said second air resonance motion damping rate stage having a second damping rate SDR wherein FDR>SDR.

3. A method as claimed in claim 2, wherein 0.5FDR>SDR.

4. A method as claimed in claim 1, wherein said helicopter has said first troublesome ground resonance motion when engaged with a ground during a takeoff/landing.

5. A method as claimed in claim 1, wherein said helicopter has said first troublesome ground resonance motion at a low rotation rate while out of flight, with said low rotation rate less than said in-flight rotary wing system rotation rate.

6. A method as claimed in 1, wherein said first centrifugal force switching damper includes an inertia moving mass, with said inertia moving mass having a switch path.

7. A method as claimed in claim 6, wherein said inertia moving mass is a sprung mass.

8. A method as claimed in 1, wherein said first centrifugal force switching damper contains a suspended fluid flow inhibitor, said suspended fluid flow inhibitor increasing the flow of fluid during said in-flight rotation.

9. A helicopter damper, said helicopter damper for controlling a first troublesome ground resonance motion during ground engagement and a second troublesome air resonance motion during helicopter flight, said damper having a first high damping rate FDR for controlling said first troublesome ground resonance motion, a second low damping rate SDR for controlling said second troublesome air resonance motion, and a centrifugal force switch, wherein an in-flight rotation of said helicopter damper centrifugal force switch reduces said first high damping rate FDR down to said second low damping rate SDR.

10. A helicopter damper as claimed in claim 9, said helicopter damper having a first variable volume fluid working chamber and a second variable volume fluid working chamber with a first damping fluid flow conduit providing first damping fluid flow between said first variable volume fluid working chamber and said second variable volume fluid working chamber, said helicopter damper including a second damping fluid flow conduit between said first variable volume fluid working chamber and said second variable volume fluid working chamber, wherein said centrifugal force switch opens a reduced resistance fluid flow path between said first variable volume fluid working chamber and said second variable volume fluid working chamber through said second damping fluid flow conduit.

11. A helicopter damper as claimed in claim 10, said damper including a volume compensator, said volume compensator distal from said centrifugal force switch.

12. A helicopter damper as claimed in claim 9, wherein 0.5FDR>SDR.

13. A helicopter damper as claimed in claim 9, wherein said first troublesome ground resonance motion during ground engagement is at an out of flight rotation rate and said in-flight rotation is greater than said out of flight rotation rate.

14. A helicopter damper as claimed in claim 9, wherein said centrifugal force switch includes an inertia moving mass, with said inertia moving mass having a switch path.

15. A helicopter damper as claimed in claim 9, wherein said centrifugal force switch includes a biasing spring connected with a mass.

16. A helicopter damper as claimed in claim 15, wherein said biasing spring biases said mass to close a secondary fluid flow orifice.

17. A damper, said damper comprising:
a first variable volume fluid working chamber and a second variable volume fluid working chamber with a first damping fluid flow conduit providing a first damping fluid flow between said first variable volume fluid working chamber and said second variable volume fluid working chamber, and a second damping fluid flow conduit between said first variable volume fluid working chamber and said second variable volume fluid working chamber, and a biased mass, wherein said biased mass is biased to obstruct a second damping fluid flow through said second damping fluid flow conduit at a first low speed rotation about an axis, and a second high speed rotation about said axis moves said biased mass to unobstruct said second damping fluid flow through said second damping fluid flow conduit.

18. A damper as claimed in claim 17, said damper including a volume compensator, said volume compensator distal from said biased mass.

19. A damper as claimed in claim 17, said damper having a first high damping rate FDR when said biased mass obstructs said second damping fluid flow through said second damping fluid flow conduit, and said damper having a second low damping rate SDR with said second damping fluid flow through said second damping fluid flow conduit, with FDR>SDR.

20. A damper as claimed in claim 19, wherein 0.5FDR>SDR.

21. A damper as claimed in claim 17, wherein said second high-speed rotation about said axis is proximate an operating frequency and said first low speed rotation is below said operating frequency.

22. A damper as claimed in claim 21, wherein 0.3FDR>SDR.

23. A damper as claimed in claim 17, wherein said biased mass has a movement path proximate said second damping fluid flow conduit.

24. A damper as claimed in claim 17, wherein said second damping fluid flow conduit is an internal damper fluid flow conduit.

25. A damper as claimed in claim 17, wherein said biased mass is biased with a spring.

26. A damper as claimed in claim 17, wherein said damper includes a first bonded elastomer seal having an inner bonded elastomer interface and an outer bonded elastomer interface.

27. A damper as claimed in claim 26, wherein said damper includes a second bonded elastomer seal having an inner bonded elastomer interface and an outer bonded elastomer interface.

28. A damper as claimed in claim 27, said damper including a first outer nonworking fluid chamber and a second outer nonworking fluid chamber, said first outer nonworking fluid chamber between said first variable volume fluid working chamber and said first bonded elastomer seal, said second outer nonworking fluid chamber between said second variable volume fluid working chamber and said second bonded elastomer seal.

29. A method of making a damper having an inboard end and an outboard end, said method comprising:
providing a first variable volume fluid working chamber and a second variable volume fluid working chamber with a first damping fluid flow conduit between said first variable volume fluid working chamber and said second variable volume fluid working chamber, and a second damping fluid flow conduit between said first variable volume fluid working chamber and said second variable volume fluid working chamber;
providing a mass;
providing a spring; and
orienting said mass and said spring between said inboard end and said outboard end proximate said second damping fluid flow conduit wherein said second damping fluid flow conduit is obstructed with said spring biasing said mass towards said inboard end, and a rotation of said damper about an axis proximate said inboard end unobstructs said second damping fluid flow conduit.

30. A method as claimed in claim 29, said method including providing a damper fluid volume compensator, and disposing said damper fluid volume compensator distal from said mass.

31. A method as claimed in claim 29, wherein said damper has a first high damping rate FDR when said second damping fluid flow conduit is obstructed, and said damper having a second low damping rate SDR with said second damping fluid flow conduit unobstructed, with FDR>SDR.

32. A method as claimed in claim 31, wherein 0.5FDR>SDR.

33. A method as claimed in claim 29, wherein said rotation about said axis is proximate an operating frequency.

34. A method as claimed in claim 29, wherein said mass has a movement path proximate said second damping fluid flow conduit.

35. A method as claimed in claim 29, wherein said second damping fluid flow conduit is an internal damper fluid flow conduit.

36. A method as claimed in claim 29, including providing a first bonded elastomer seal having an inner bonded elastomer interface bonded to an inner nonelastomer damper interface inner member and an outer bonded elastomer interface bonded to an outer nonelastomer damper interface outer member, and containing a damper fluid in said damper with said first bonded elastomer seal.

37. A method as claimed in claim 36, including providing a second bonded elastomer seal having an inner bonded elastomer interface bonded to an inner nonelastomer damper interface inner second member and an outer bonded elastomer interface bonded to an outer nonelastomer damper interface outer second member, and containing said damper fluid in said damper with said second bonded elastomer seal.

38. A method as claimed in claim 37, including, providing a first outer nonworking fluid chamber and a second outer nonworking fluid chamber, said first outer nonworking fluid chamber between said first variable volume fluid working chamber and said first bonded elastomer seal, said second outer nonworking fluid chamber between said second variable volume fluid working chamber and said second bonded elastomer seal.

39. A machine, said machine comprising:
a rotary system rotating about a rotation axis, said machine having a first motion during rotation about said rotation axis at a first low rotation rate and a second motion during rotation about said rotation axis at a second high rotation rate;
a centrifugal force switching fluid damper, said centrifugal force switching fluid damper having a first motion damping rate stage and a second motion centrifugally switched damping rate stage switched with a centrifugal force inertia switch; and
said centrifugal force switching fluid damper oriented relative to said rotation axis wherein said second high rotation rate centrifugally switches said centrifugal force switching fluid damper from said first motion damping rate stage to said second motion centrifugally switched damping rate stage.

40. A machine as claimed in claim 39, wherein said centrifugal force switching fluid damper includes:
a first variable volume fluid working chamber;
a second variable volume fluid working chamber with a first damping fluid flow conduit between said first variable volume fluid working chamber and said second variable volume fluid working chamber; and
a second damping fluid flow conduit between said first variable volume fluid working chamber and said second variable volume fluid working chamber;
a mass; and
a spring, with said mass and said spring proximate said second damping fluid flow conduit, wherein said second damping fluid flow conduit is obstructed with said spring biasing said mass towards said rotation axis, and said second high rotation rate unobstructs said second damping fluid flow conduit.

41. A machine as claimed in claim 39, wherein said damper has a first high damping rate FDR when said second damping fluid flow conduit is obstructed, and said damper having a second low damping rate SDR with said second damping fluid flow conduit unobstructed, with FDR>SDR.

42. A machine as claimed in claim 41, wherein 0.5FDR>SDR.

43. A machine as claimed in claim 39, wherein said second high rotation rate is proximate an operating frequency of said machine.

44. A machine as claimed in claim 40, wherein said mass has a movement path proximate said second damping fluid flow conduit.

45. A machine as claimed in claim 40, wherein said second damping fluid flow conduit is an internal damper fluid flow conduit.

46. A machine as claimed in claim 39, wherein said centrifugal force switching fluid damper includes, a first bonded elastomer seal having an inner bonded elastomer interface bonded to an inner nonelastomer damper interface inner member and an outer bonded elastomer interface bonded to an outer nonelastomer damper interface outer member, and said centrifugal force switching fluid damper containing a damper fluid in said damper with said first bonded elastomer seal.

47. A machine as claimed in claim 46, wherein said centrifugal force switching fluid damper includes a second bonded elastomer seal having an inner bonded elastomer interface bonded to an inner nonelastomer damper interface inner second member and an outer bonded elastomer interface bonded to an outer nonelastomer damper interface outer second member, and said centrifugal force switching fluid damper contains said damper fluid in said damper with said first and said second bonded elastomer seals.

48. A machine as claimed in claim 47, wherein said centrifugal force switching fluid damper includes a first outer nonworking fluid chamber and a second outer nonworking fluid chamber, said first outer nonworking fluid chamber between said first variable volume fluid working chamber and said first bonded elastomer seal, said second outer nonworking fluid chamber between said second variable volume fluid working chamber and said second bonded elastomer seal.

49. A process, said process including:
providing a helicopter rotor which rotates about a helicopter axis of rotation;
providing a rotation rate switched fluid damper containing a damper fluid in a fluid damper housing, said rotation rate switched damper housing having an inboard end and an outboard end; and
orienting said rotation rate switched fluid damper with said inboard end proximate said helicopter axis of rotation and said outboard end distal from said helicopter axis of rotation wherein with a helicopter out of flight rotation of said helicopter rotor and said rotation rate switched fluid damper, said rotation rate switched fluid damper provides a first damping rate FDR, and with a helicopter in-flight rotation of said helicopter rotor and said rotation rate switched fluid damper, said rotation rate switched fluid damper provides a second damping rate SDR with FDR>SDR.

50. A process as claimed in claim 49, wherein 0.5FDR>SDR.

51. A process as claimed in claim 49, wherein said rotation rate switched fluid damper includes an inertia moving mass, with said inertia moving mass having a switch path within said damper housing

52. A process as claimed in claim 51, wherein said inertia moving mass is a sprung mass.

53. A process as claimed in claim 49, wherein said rotation rate switched fluid damper includes a suspended fluid flow inhibitor, said suspended fluid flow inhibitor increasing the flow of fluid during said in-flight rotation.

54. A process as claimed in claim 49, wherein said rotation rate switched fluid damper contains a first variable volume fluid working chamber and a second variable volume fluid working chamber with a first damping fluid flow conduit between said first variable volume fluid working chamber and said second variable volume fluid working chamber, and a second damping fluid flow conduit between said first variable volume fluid working chamber and said second variable volume fluid working chamber.

55. A process as claimed in claim 54, wherein said rotation rate switched fluid damper contains a mass and a spring between said inboard end and said outboard end, with said mass proximate said second damping fluid flow conduit wherein said second damping fluid flow conduit is obstructed with said spring biasing said mass towards said inboard end, and said helicopter in-flight rotation unobstructs said second damping fluid flow conduit.

56. A process as claimed in claim 49, wherein said damper fluid does not flow outside said housing.

57. A process as claimed in claim 49, wherein said rotation rate switched fluid damper includes a first bonded elastomer seal having an inner bonded elastomer interface bonded to an inner nonelastomer damper interface inner member and an outer bonded elastomer interface bonded to an outer nonelastomer damper interface outer member.

58. A process as claimed in claim 57, wherein said rotation rate switched fluid damper includes a second bonded elastomer seal having an inner bonded elastomer interface bonded to an inner nonelastomer damper interface inner second member and an outer bonded elastomer interface bonded to an outer nonelastomer damper interface outer second member.

59. A process as claimed in claim 58, wherein said rotation rate switched fluid damper includes a first outer nonworking fluid chamber and a second outer nonworking fluid chamber, said first outer nonworking fluid chamber between a first variable volume fluid working chamber and said first bonded elastomer seal, said second outer nonworking fluid chamber between a second variable volume fluid working chamber and said second bonded elastomer seal.

60. A process as claimed in claim 49, wherein said rotation rate switched fluid damper is not electromagnetically switched.

61. A lead-lag damper comprising:
a first variable volume fluid working chamber;
a second variable volume fluid working chamber;
a first damping fluid flow conduit disposed between the first variable volume fluid working chamber and the second variable volume fluid working chamber;
a second damping fluid flow conduit between the first variable volume fluid working chamber and the second variable volume fluid working chamber,
a piston;
an inertial mass positioned within the piston;
a restraining spring, wherein the restraining spring is positioned to exert a bias force on inertial mass to obstruct second damping fluid flow conduit at a first low speed rotation about an axis, and
wherein the inertial mass is capable of overcoming the bias force of the restraining spring and unobstruct the second damping fluid flow conduit at a second high speed rotation about the axis.

62. A lead-lag damper as claimed in claim 61, the damper including a volume compensator, the volume compensator distal from the biased mass.

63. A lead-lag damper as claimed in claim 61, the damper having a first high damping rate FDR when the biased mass obstructs the second damping fluid flow through the second damping fluid flow conduit, and the damper having a second low damping rate SDR with the second damping fluid flow through the second damping fluid flow conduit, with FDR>SDR.

64. A lead-lag damper as claimed in claim 63, wherein 0.5FDR>SDR.

65. A lead-lag damper as claimed in claim 61, wherein the second high-speed rotation about the axis is proximate an operating frequency and the first low speed rotation is below the operating frequency.

66. A lead-lag damper as claimed in claim 65, wherein 0.3FDR>SDR.

67. A lead-lag damper as claimed in claim 61, wherein the biased mass has a movement path proximate the second damping fluid flow conduit.

68. A lead-lag damper as claimed in claim 61, wherein the second damping fluid flow conduit is an internal damper fluid flow conduit.

69. A lead-lag damper as claimed in claim 61, wherein the biased mass is biased with a spring.

70. A lead-lag damper as claimed in claim 61, wherein the damper includes a first bonded elastomer seal having an inner bonded elastomer interface and an outer bonded elastomer interface.

71. A lead-lag damper as claimed in claim 70, wherein the damper includes a second bonded elastomer seal having an inner bonded elastomer interface and an outer bonded elastomer interface.

72. A lead-lag damper as claimed in claim 71, the damper including a first outer nonworking fluid chamber and a second outer nonworking fluid chamber, the first outer nonworking fluid chamber between the first variable volume fluid working chamber and the first bonded elastomer seal, the second outer nonworking fluid chamber between the second variable volume fluid working chamber and the second bonded elastomer seal.

73. A lead-lag damper as claimed in claim 61, where a radial component of a centrifugal force acts upon the inertial mass thereby changing the position from FDR to SDR.
